(19) United States
(12) Patent Application Publication
(10) Pub. No.: US 2025/0063392 A1
(43) Pub. Date: Feb. 20, 2025

(54) COMMUNICATION METHOD AND DEVICE

(71) Applicant: GUANGDONG OPPO MOBILE TELECOMMUNICATIONS CORP., LTD., Dongguan (CN)

(72) Inventors: Jiangsheng FAN, Dongguan (CN); Xin YOU, Dongguan (CN); Xue LIN, Dongguan (CN)

(73) Assignee: GUANGDONG OPPO MOBILE TELECOMMUNICATIONS CORP., LTD., Dongguan (CN)

(21) Appl. No.: 18/937,522

(22) Filed: Nov. 5, 2024

Related U.S. Application Data
(63) Continuation of application No. PCT/CN2022/091200, filed on May 6, 2022.

(51) Int. Cl. H04W 24/02; H04W 8/22; H04W 60/04; H04W 60/06

(52) U.S. Cl. CPC H04W 24/02; H04W 8/22; H04W 60/04; H04W 60/06

(57) ABSTRACT

This application relates to a communication method and a device. The communication method includes: transmitting, by a first device, a first message to a second device, where the first message is used to request at least one of the following operations: downloading application model data or adding application model data; updating application model data or modifying application model data; uploading application model data; or deleting application model data.

### CROSS-REFERENCE TO RELATED APPLICATIONS

This application is a continuation of International Application No. PCT/CN2022/091200, filed on May 6, 2022, the disclosure of which is hereby incorporated by reference in its entirety.

### TECHNICAL FIELD

This application relates to the communications field, and more specifically, to a communication method and a device.

### RELATED ART

With the continuous development of artificial intelligence (AI, Artificial Intelligence) technologies and machine learning (ML, Machine Learning) technologies, a combination of a communication technology and an AI/ML technology is one of future communication trends. Because scenarios of communications systems are complex, different models may be required for optimizing different communication scenarios. As a result, how to manage models becomes a technical problem that needs to be resolved.

### SUMMARY

Embodiments of this application provide a communication method and a device, to implement model management.

An embodiment of this application provides a communication method, including:
transmitting, by a first device, a first message to a second device, where the first message is used to request at least one of the following operations:
downloading application model data or adding application model data;
updating application model data or modifying application model data;
uploading application model data; or
deleting application model data.

An embodiment of this application provides a first device, including a processor and a memory, where the memory is configured to store a computer program, and the processor is configured to invoke the computer program stored in the memory and run the computer program, to cause the first device to execute a method of:
transmitting a first message, where the first message is used to request at least one of the following operations:
downloading application model data or adding application model data;
updating application model data or modifying application model data;
uploading application model data; or
deleting application model data.

An embodiment of this application provides a second device, including a processor and a memory, wherein the memory is configured to store a computer program, and the processor is configured to invoke the computer program stored in the memory and run the computer program, to cause the second device to execute a method of:
receiving a first message from a first device, where the first message is used to request at least one of the following operations:
downloading application model data or adding application model data;
updating application model data or modifying application model data;
uploading application model data; or
deleting application model data.

### BRIEF DESCRIPTION OF DRAWINGS

FIG. 1 is a schematic diagram of an application scenario according to an embodiment of this application.

FIG. 2 is a schematic flowchart of a communication method 200 according to an embodiment of this application.

FIG. 3 is a schematic diagram of an entire flow of model data transmission according to an embodiment of this application.

FIG. 4 is a schematic flowchart of a communication method 400 according to an embodiment of this application.

FIG. 5 is a schematic block diagram of a first device 500 according to an embodiment of this application.

FIG. 6 is a schematic block diagram of a first device 600 according to an embodiment of this application.

FIG. 7 is a schematic block diagram of a second device 700 according to an embodiment of this application.

FIG. 8 is a schematic block diagram of a second device 800 according to an embodiment of this application.

FIG. 9 is a schematic block diagram of a communications device 900 according to an embodiment of this application.

FIG. 10 is a schematic block diagram of a chip 1000 according to an embodiment of this application.

FIG. 11 is a schematic block diagram of a communications system 1100 according to an embodiment of this application.

### DESCRIPTION OF EMBODIMENTS

The following describes technical solutions in embodiments of this application with reference to accompanying drawings in the embodiments of this application.

The technical solutions in the embodiments of this application may be applied to various communications systems, for example, a global system for mobile communication (GSM), a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunications system (UMTS), a wireless local area network (WLAN), wireless fidelity (WiFi), a fifth-generation (5G) system, or another communications system.

Generally, a quantity of connections supported by a conventional communications system is limited and is also easy to implement. With development of communication technologies, a mobile communications system not only supports conventional communication, but also supports, for example, device-to-device (D2D) communication, machine-to-machine (M2M) communication, machine type communication (MTC), vehicle-to-vehicle (V2V) communication, or vehicle-to-everything (V2X) communication. Embodiments of this application may also be applied to these communications systems.

In an implementation, a communications system in embodiments of this application may be applied to a carrier aggregation (CA) scenario, a dual connectivity (DC) scenario, or a standalone (SA) networking scenario.

In an implementation, a communications system in embodiments of this application may be applied to an unlicensed spectrum, and the unlicensed spectrum may also be considered as a shared spectrum. Alternatively, a communications system in embodiments of this application may be applied to a licensed spectrum, and the licensed spectrum may also be considered as a non-shared spectrum.

Embodiments of this application are described with reference to a network device and a terminal device. The terminal device may also be referred to as user equipment (UE), an access terminal, a user unit, a user station, a mobile site, a mobile station, a remote station, a remote terminal, a mobile device, a user terminal, a terminal, a wireless communications device, a user agent, a user apparatus, or the like.

The terminal device may be a station (ST) in a WLAN, may be a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next-generation communications system such as an NR network, or a terminal device in a future evolved public land mobile network (PLMN), or the like.

In embodiments of this application, the terminal device may be deployed on land, including being indoors or outdoors, handheld, wearable, or vehicle-mounted. The terminal device may also be deployed on water (for example, on a ship), or may be deployed in the air (for example, on an airplane, an air balloon, or a satellite).

In embodiments of this application, the terminal device may be a mobile phone (Mobile Phone), a tablet computer (Pad), a computer with a wireless transceiver function, a virtual reality (VR) terminal device, an augmented reality (AR) terminal device, a wireless terminal device in industrial control (industrial control), a wireless terminal device in self driving (self driving), a wireless terminal device in remote medical (remote medical), a wireless terminal device in smart grid (smart grid), a wireless terminal device in transportation safety (transportation safety), a wireless terminal device in smart city (smart city), or a wireless terminal device in smart home (smart home), or the like.

By way of example rather than limitation, in embodiments of this application, the terminal device may alternatively be a wearable device. The wearable device may also be referred to as a smart wearable device, and is a general term for wearable devices, such as glasses, gloves, watches, clothes, and shoes, that are intelligently designed and developed based on daily wearing by using a wearable technology. The wearable device is a portable device that can be directly worn or integrated into clothes or accessories of a user. In addition to being a hardware device, the wearable device can also realize various functions through software support, data interaction, and cloud interaction. In a broad sense, the wearable smart device includes a full-featured and large-sized device that can implement some or all of functions without relying on a smartphone, for example, a smart watch or smart glasses, and a device that only focuses on a specific type of application function and needs to cooperate with another device such as a smartphone, for example, various smart bracelets and smart jewelries for physical sign monitoring.

In embodiments of this application, the network device may be a device configured to communicate with a mobile device. The network device may be an access point (AP) in a WLAN, a base transceiver station (BTS) in GSM or CDMA, a NodeB (NodeB, NB) in WCDMA, an evolved Node B (Evolutional Node B, eNB or eNodeB) in LTE, a relay station or an access point, a vehicle-mounted device, a wearable device, a network device (gNB) in an NR network, a network device in a future evolved PLMN network, a network device in an NTN network, or the like.

By way of example rather than limitation, in embodiments of this application, the network device may have a mobility characteristic. For example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. Optionally, the network device may alternatively be a base station disposed in a location such as land or water.

In embodiments of this application, the network device may provide a service for a cell. The terminal device communicates with the network device by using a transmission resource (for example, a frequency domain resource or a spectrum resource) used by the cell. The cell may be a cell corresponding to the network device (for example, a base station). The cell may belong to a macro station or may belong to a base station corresponding to a small cell (Small cell). The small cell herein may include a metro cell (Metro cell), a micro cell (Micro cell), a pico cell (Pico cell), a femto cell (Femto cell), or the like. These small cells have a characteristic of a small coverage range and low transmit power, and are applicable to providing a high-rate data transmission service.

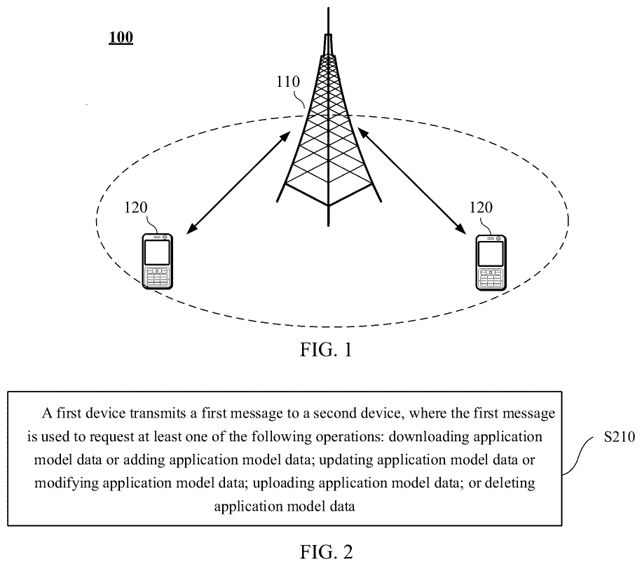

FIG. 1 exemplarily shows a communications system 100. The communications system includes one network device 110 and two terminal devices 120. In an implementation, the communications system 100 may include a plurality of network devices 110, and another quantity of terminal devices 120 may be included in a coverage range of each network device 110, which is not limited in embodiments of this application.

In an implementation, the communications system 100 may further include another network entity such as a mobility management entity (MME) or an access and mobility management function (AMF), which is not limited in embodiments of this application.

The network device may further include an access network device and a core network device, that is, the wireless communications system further includes a plurality of core networks configured to communicate with the access network device. The access network device may be an evolved node B (evolutional node B, which may be an eNB or an e-NodeB for short), a macro base station, a micro base station (also referred to as a “small base station”), a pico base station, an access point (AP), a transmission point (TP), or a new generation Node B (gNodeB), or the like in a long-term evolution (LTE) system, a next-generation (mobile communications system) (next radio, NR) system, or an authorized auxiliary access long-term evolution (LAA-LTE) system.

It should be understood that in embodiments of this application, a device having a communication function in a network/system may be referred to as a communications device. The communications system shown in FIG. 1 is used as an example. The communications device may include a network device and a terminal device that have a communication function. The network device and the terminal device may be specific devices in embodiments of this application. Details are not described herein again. The communications device may further include another device in the communications system, for example, another network entity such as a network controller or a mobility management entity. This is not limited in embodiments of this application.

It should be understood that the terms “system” and “network” in this specification may often be used interchangeably in this specification. In this specification, the term “and/or” is merely an association that describes associated objects, and indicates that three relationships may exist. For example, A and/or B may represent three cases: only A exists, both A and B exist, and only B exists. In addition, the character “/” in this specification generally indicates an “or” relationship between associated objects.

It should be understood that, the “indication” mentioned in embodiments of this application may be a direct indication or an indirect indication, or indicate an association. For example, “A indicates B” may mean that A indicates B directly, where for example, B may be obtained by using A; may mean that A indicates B indirectly, where for example, A indicates C, and B may be obtained by using C; or may mean that there is an association between A and B.

In the description of embodiments of this application, the term “corresponding” may mean that there is a direct or indirect correspondence between two elements, or that there is an association between two elements, or that there is a relationship of “indicating” and “being indicated”, “configuring” and “being configured”, or the like.

To facilitate understanding of the technical solutions in embodiments of this application, the following describes related technologies in embodiments of this application. The following related technologies, as optional solutions, may be randomly combined with the technical solutions of embodiments of this application, all of which fall within the protection scope of embodiments of this application.

In recent years, researches of artificial intelligence and related findings have achieved good results in many fields. At present, artificial intelligence has become a new way for people to try to resolve and deal with problems. Among many researches, neural network-based artificial intelligence researches are an extremely important category. A basic structure of a simple neural network includes an input layer, a hidden layer, and an output layer. The input layer receives data. The hidden layer processes the data. The output layer generates a final result.

With the continuous development of neural network researches, a neural network deep learning algorithm is also proposed in recent years. A multi-hidden layer neural network structure greatly improves a processing capability of a network, and is widely used in fields such as pattern recognition, signal processing, optimal combination, and anomaly detection.

Likewise, with the development of deep learning, convolutional neural networks have been further researched. A basic structure of a convolutional neural network includes an input layer, a plurality of convolutional layers, a plurality of pooling layers, a fully connected layer, and an output layer. Due to introduction of the convolutional layers and the pooling layers, dramatic increase of network parameters is controlled effectively, a quantity of parameters is limited, features of a local structure are mined, thereby improving robustness of an algorithm.

With the continuous development of artificial intelligence (AI) technologies and machine learning (ML) technologies, a combination of a communication technology and an AI/ML technology is one of future communication trends. Due to complexity of scenarios of communications systems, for example, application scenarios such as paging, measurement, and mobility, different AI/ML models may be required for optimizing different communication scenarios. As a result, management of a large quantity of AI/ML models becomes complex, and how to manage AI/ML models becomes a technical problem that needs to be resolved. Embodiments of this application provide a solution for efficiently downloading, updating, or deleting model data or the like.

FIG. 2 is a schematic flowchart of a communication method 200 according to an embodiment of this application. Optionally, the method may be applied to the system shown in FIG. 1, but is not limited thereto. The method includes at least step S210.

In step S210, a first device transmits a first message to a second device, where the first message is used to request at least one of the following operations:
downloading application model data or adding application model data;
updating application model data or modifying application model data;
uploading application model data; or
deleting application model data.

In embodiments of this application, the first device transmits, to the second device, the first message that is used to request for performing a related operation on the application model data, so that model management can be implemented.

In an implementation, the first device in embodiments of this application may include a terminal device.

In an implementation, the second device in embodiments of this application may include a network device or a terminal device.

The network device may include an access network device, a core network device, or an application model control device.

For example, the application model control device may be a special access network device or a special core network device. The application model control device may be mainly configured to manage an application model, for example, perform operations of model data, such as transfer, registration management, storage, addition, update, deletion, modification, upload, and download.

In some implementations, a data module corresponding to the application model data provided in embodiments of this application includes at least one of the following:
a model input data module, a model output data module, a model training data module, a model inference data module, a model storage data module, a model computing data module, a model structure data module, or a model coordination control data module.

It should be noted that data corresponding to an application model may be divided into multiple data sub-modules, where each data sub-module corresponds to some logical functions of the model. In an implementation, one model data sub-block identifier is allocated to each data sub-module, which facilitates management of the model data, for example, downloading and updating the model data at a granularity of a model data sub-block. Compared with a manner of downloading application model data completely, this manner is more efficient.

In some implementations, an application model corresponding to the application model data provided in embodiments of this application includes at least one of the following:
an AI model, an ML model, a supercomputing model, a neuron-like model, an authentication model, an encryption and decryption model, or a self-optimization model.

For example, the application model itself may be understood as a special data block, and it may be possible to perform overall cooperation between data of the data block. Generally, the application model data may be divided into one or more model data sub-blocks according to different functions. This data division mode facilitates flexible transmission and differential transmission of the model data.

In some implementations, the first message may include at least one of the following: model identifier information corresponding to at least one application model that is requested to be downloaded or added;
sub-block identifier information of a model data sub-block corresponding to at least one application model that is requested to be downloaded or added;
model identifier information corresponding to at least one application model that is requested to be updated or modified;
sub-block identifier information of a model data sub-block corresponding to at least one application model that is requested to be updated or modified;
model identifier information corresponding to at least one application model that is requested to be uploaded;
model quality of service (QOS) requirement information corresponding to at least one application model that is requested to be uploaded;
model data size indication information corresponding to at least one application model that is requested to be uploaded;
sub-block identifier information of a model data sub-block corresponding to at least one application model that is requested to be uploaded;
QoS requirement information of a model data sub-block corresponding to at least one application model that is requested to be uploaded;
sub-block data size indication information of a model data sub-block corresponding to at least one application model that is requested to be uploaded;
model identifier information corresponding to at least one application model that is requested to be deleted; or
sub-block identifier information of a model data sub-block corresponding to at least one application model that is requested to be deleted.

By transmitting first message to a network device or a second terminal device, a first terminal device can request, from the network device or the second terminal device, performing an operation such as downloading, adding, updating, modifying, uploading, or deleting an application model or a model data sub-block in an application model; and provide the network device or the second terminal device with related information for performing the foregoing operation.

### Example 1

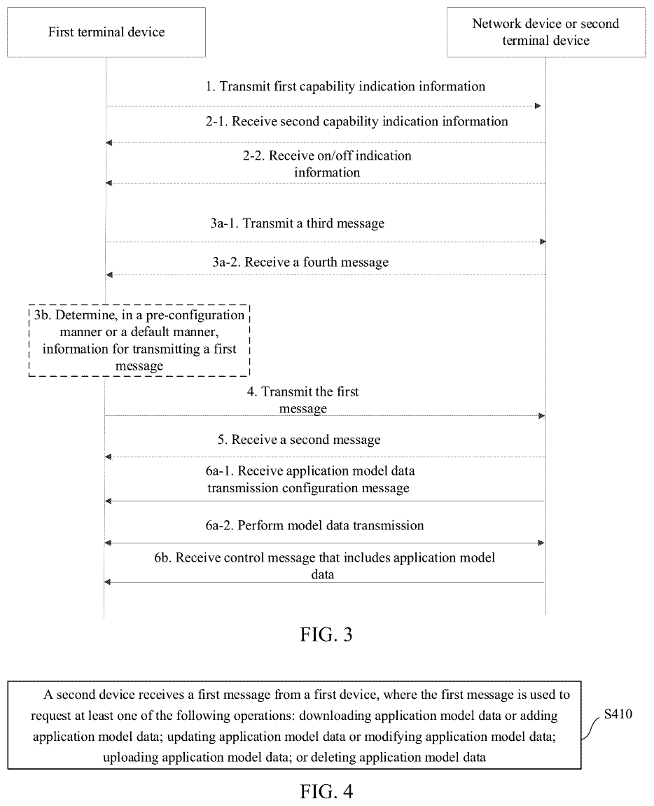

FIG. 3 is a schematic diagram of an entire flow of model data transmission according to an embodiment of this application. As shown in FIG. 3, the model data transmission flow may include steps 1 to 6b as follows.

In step 1, a first device (for example, a first terminal device) transmits first capability indication information to a second device (for example, a network device or a second terminal device), where the first capability indication information is used to indicate whether the first device is capable of supporting an application model-related operation.

In step 2-1, the first device (for example, the first terminal device) receives second capability indication information from the second device (for example, the network device or the second terminal device), where the second capability indication information indicates whether the second device is capable of supporting an application model-related operation.

In step 2-2, the first device (for example, the first terminal device) receives on/off indication information from the second device (for example, the network device or the second terminal device), where the on/off indication information is used to indicate whether the first device is allowed to perform an application model-related operation.

Both step 1 and step 2-1 are optional steps. There may be the following scenarios: only step 1 exists but step 2-1 does not exist; only step 2-1 exists but step 1 does not exist; and both step 1 and step 2-1 exist. In the last scenario, a message in step 2-1 may be a response message of a message in step 1, or may be a message independent of step 1. If the messages in step 2-1 and step 1 are mutually independent messages, an order for performing step 1 and step 2-1 is not limited. Moreover, an order for performing step 1 and another step and an order for performing step 2-1 and another step are not limited in this application. FIG. 3 shows merely an example. Content of the foregoing description is not limited in this application.

In addition, step 2-2 is also an optional step. If the first device does not receive the on/off indication information from the second device, the first device may be allowed by default to perform the application model-related operation. Alternatively, if the first device does not receive the on/off indication information from the second device, the first device determines, based on content of the message in step 2-1, whether to perform the application model-related operation. An order for performing step 2-2 and another step is not limited in embodiments of this application.

In step 3a-1, the first device (for example, the first terminal device) transmits a third message to the second device (for example, the network device or the second terminal device). The third message may be used to request performing an operation related to registration of application model data, and/or used to request obtaining model data format control information.

In step 3a-2, the first device (for example, the first terminal device) receives a fourth message from the second device (for example, the network device or the second terminal device).

Both step 3a-1 and step 3a-2 are optional steps. There may be the following three implementations.

Implementation 1: in a scenario in which only step 3a-1 exists but step 3a-2 does not exist, the first terminal device transmits the third message without a response message from the network device or the second terminal device. For example, it is assumed that content of a model registration request transmitted by the first terminal device will be accepted by default by the network device or the second terminal device. In this case, the network device or the second terminal device is unnecessary to respond to the model registration request of the first terminal device.

Implementation 2: in a scenario in which only step 3a-2 exists but step 3a-1 does not exist, the first terminal device passively receives the fourth message transmitted by the network device or the second terminal device. In this implementation, the first terminal device is unnecessary to transmit a model registration request message. For example, the network device or the second terminal device transmits content of the fourth message as updated configuration information to the first terminal device, without depending on whether the first terminal device has transmitted the third message. This is because a configuration information updating operation may be triggered at any time instant based on implementation.

Implementation 3: in a scenario in which both step 3a-1 and step 3a-2 exist, the fourth message in step 3a-2 is a response message of the third message in step 3a-1. For example, the first terminal device transmits the third message for requesting registration of a model 1 and a model 2, and the network device or the second terminal device replies to the first terminal device with the fourth message indicating that only the model 2 is allowed to be registered. Alternatively, the first terminal device transmits the third message for requesting registration of a model 1 and a model 2, and the network device or the second terminal device replies to the first terminal device with the fourth message indicating that the third message has been received successfully. This manner implies that all content which is requested to be registered via the third message is allowed by the network device or the second terminal device.

None of the foregoing implementations is limited in embodiments of this application.

In step 3b, the first terminal device determines, in a pre-configuration manner or a default manner, information for transmitting a first message, for example, determines model data format control information corresponding to at least one application model.

Step 3b is an optional step. A logical relationship between step 3a (including step 3a-1 and/or step 3a-2) and step 3b may be expressed in the following implementations 1 to 4.

Implementation 1: both step 3a and step 3b exist, where step 3a is performed to complete an operation related to registration of application model data, and step 3b is performed to determine model data format control information corresponding to at least one application model.

Implementation 2: both step 3a and step 3b exist, where step 3a is performed to complete an operation related to registration of application model data and obtain model data format control information, or step 3a is performed to obtain only model data format control information; and step 3b is performed to determine model data format control information corresponding to at least one application model. Because model data format control information can be obtained by step 3a or step 3b, a priority may be defined to resolve a conflict if the model data format control information obtained for the same application model data in the foregoing two steps differs from each other. For example, a priority of model data format control information obtained in step 3a is always higher than that of model data format control information obtained in step 3b. Certainly, the following scenarios may be defined in a protocol: scenarios in which model data format control information obtained in step 3b covers information obtained in step 3a, and scenarios in which model data format control information obtained in step 3a covers information obtained in step 3b. The scenarios are not limited in this application.

Implementation 3: only step 3a exists, where step 3a is performed to complete an operation related to registration of application model data and/or obtain model data format control information.

Implementation 4: only step 3b exists, where step 3b is performed to obtain model data format control information.

In step 4, the first device (for example, the first terminal device) transmits a first message to the second device (for example, the network device or the second terminal device), where the first message may be used to request performing at least one of the following operations on application model data: downloading, adding, updating, modifying, uploading, deleting, or the like.

In some implementations, the first message may be a non-access stratum (NAS) message, an access stratum (AS) message, or an application model operation-specific control message.

In step 5, the first device (for example, the first terminal device) receives a second message from the second device (for example, the network device or the second terminal device), where the second message may be used to indicate whether an operation requested by the first message is allowed.

In some implementations, the second message may be a non-access stratum (NAS) message, an access stratum (AS) message, or an application model operation-specific control message.

Step 5 is an optional step. In some implementations, the second message does not exist.

In step 6a-1, the first device (for example, the first terminal device) receives an application model data transmission configuration message from the second device (for example, the network device or the second terminal device), where the application model data transmission configuration message is used to determine resource configuration information for transmitting corresponding application model data.

In step 6a-2, the first device (for example, the first terminal device) receives or uploads the application model data based on the resource configuration information included in the application model data transmission configuration message.

By performing step 6a-1 and step 6a-2, the first device receives the application model data. Then, the first device may reassemble the received application model data.

In step 6b, the first device (for example, the first terminal device) receives, from the second device (for example, the network device or the second terminal device), a control message that includes the application model data.

By performing step 6b, the first device receives the application model data. Then, the first device may reassemble, based on content of the control message, the application model data that is received via a plurality of control messages.

Steps 6a and 6b are optional steps. Generally, it is unnecessary to perform both step 6b and step 6a (including step 6a-1 and step 6a-2). Both step 6b and step 6a can independently transmit the application model data. Certainly, this application does not exclude a scenario in which both step 6a and step 6b are defined. In this case, the second device determines to transmit the application model data by performing step 6a or step 6b.

It should be additionally noted that when at least one of step 6a or step 6b exist (is defined), step 4 may not be performed. For example, the second device delivers the application model data to the first device directly by performing step 6a or step 6b. In this case, the first device is unnecessary to transmit the first message to request transmission of the corresponding application model data.

In some implementations, after the first device reassembles the received application model data, the method further includes:
transferring reassembled application model data to an application model data management module; or
transferring reassembled application model data to a corresponding function module according to a preset rule.

The foregoing application model data management module is configured to manage all the application model data in a unified manner in the first device.

The foregoing preset rule may include any one of the following:
the reassembled application model data is transferred to the corresponding function module based on model identifier information corresponding to the application model data;
the reassembled application model data is transferred to the corresponding function module based on route indication information included in the application model data; or
the reassembled application model data is transferred to the corresponding function module based on model identifier information corresponding to the application model data and route indication information included in the application model data.

The foregoing function module may include at least one of the following: an application layer, a NAS, a radio resource control (RRC) layer, a service data adaptation protocol (SDAP) layer, a packet data convergence protocol (PDCP) layer, a radio link control (RLC) layer, a medium access control (MAC) layer, a backhaul adaptation protocol (BAP) layer, or a physical layer.

In the following examples, messages in the foregoing steps are separately described in detail.

### Example 2

In this example, the first message in step 4 in FIG. 3 may include at least one of the following information:
information 1: model identifier information corresponding to at least one application model that is requested to be downloaded or added;
information 2: sub-block identifier information of a model data sub-block corresponding to at least one application model that is requested to be downloaded or added;
information 3: model identifier information corresponding to at least one application model that is requested to be updated or modified;
information 4: sub-block identifier information of a model data sub-block corresponding to at least one application model that is requested to be updated or modified;
information 5: model identifier information corresponding to at least one application model that is requested to be uploaded;
information 6: model QoS requirement information corresponding to at least one application model that is requested to be uploaded;
information 7: model data size indication information corresponding to at least one application model that is requested to be uploaded;
information 8: sub-block identifier information of a model data sub-block corresponding to at least one application model that is requested to be uploaded;
information 9: QOS requirement information of a model data sub-block corresponding to at least one application model that is requested to be uploaded;
information 10: sub-block data size indication information of a model data sub-block corresponding to at least one application model that is requested to be uploaded;
information 11: model identifier information corresponding to at least one application model that is requested to be deleted; or
information 12: sub-block identifier information of a model data sub-block corresponding to at least one application model that is requested to be deleted.

In some implementations, the first message may include a NAS message, an AS message, or an application model operation-specific control message.

The foregoing AS message may include any one of the following messages: a radio resource control (RRC) message, a medium access control (MAC) control element (CE) message, or an uplink control information (UCI) message.

The foregoing application model operation-specific control message may be a message specifically defined for the application model, and may be used to carry control information related to performing an application model operation.

The foregoing information 1 and information 2 may be implemented in at least the following two manners:

### Manner 1:

In this manner, functions corresponding to information 1 and information 2 may be implemented according to Table 1.

TABLE 1
The first message includes the following information:

| List-type parameters related to information 1 and information 2 are as follows: | | | | | | | |
|---|---|---|---|---|---|---|---|
| List element 1 | | List element 2 | | . . . | List element N | | |
| Identifier 1 of | (Optional field) | Identifier 2 of | (Optional field) | . . . | Identifier N of | (Optional field) | Other |
| a model that is | List 1 of | a model that is | List 2 of | | a model that is | List N of | parameters [symbol] |
| requested to be | sub-block | requested to be | sub-block | | requested to be | sub-block | included in |
| downloaded | identifiers of | downloaded | identifiers of | | downloaded | identifiers of | the first [symbol] |
| | the model that | | the model that | | | the model that | message |
| | is requested to | | is requested to | | | is requested to | |
| | be downloaded | | be downloaded | | | be downloaded | |

[symbol]

indicates data missing or illegible when filed

In Table 1, N is a positive integer. As shown in Table 1, each list-type parameter related to information 1 and information 2 includes at least one list element, and each list element includes one mandatory field and one optional field. The mandatory field carries model identifier information corresponding to an application model that is requested to be downloaded. The optional field carries a model sub-block identifier list corresponding to the model that is requested to be downloaded. The model sub-block identifier list may include sub-block identifier information corresponding to at least one model data sub-block that is requested to be downloaded.

If a list element includes only a mandatory field, it indicates that the first terminal device requests downloading all data corresponding to the application model. If a list element includes both a mandatory field and an optional field, it indicates that the first terminal device requests downloading some of the data corresponding to the application model (that is, does not request all the data corresponding to the application model), where the optional field indicates a to-be-downloaded portion (a data model sub-block) of the data corresponding to the application model. The implementation in Table 1 can flexibly implement the following three functions: only requesting all data of at least one application model (a scenario in which none of the optional fields of the list elements exist), only requesting some of data of at least one application model (a scenario in which all the optional fields of the list elements exist), or simultaneously requesting all data of at least one application model and requesting some of data of at least one application model (a scenario in which optional fields of some of the list elements do not exist but optional fields of the remaining list elements exist).

### Manner 2:

In this manner, functions corresponding to information 1 and information 2 may be implemented according to Table 2.

TABLE 2
The first message includes the following information:

| Parameter of | List-type parameters of information 2 | | | | |
|---|---|---|---|---|---|
| information 1 | List element 1 | List element 2 | . . . | List element N | |
| Identifier list | Model identifier 1 | Model identifier 2 | . . . | Model identifier N | Other |
| of models that | and list 1 of sub- | and list 2 of sub- | | and list N of sub- | parameters |
| are requested | block identifiers | block identifiers | | block identifiers | included |
| to be downloaded | of a model that | of a model that | | of a model that | in the first |
| | is requested to | is requested to | | is requested to | message |
| | be downloaded | be downloaded | | be downloaded | |

In Table 2, N is a positive integer. As shown in Table 2, information 1 and information 2 correspond to different parameters. The parameter corresponding to information 1 is used to request for downloading all data of at least one application model. Each list-type parameter corresponding to information 2 includes at least one list element. Each list element includes two sub-parameters, namely, model identifier information and a model sub-block identifier list corresponding to a model that is requested to be downloaded (the model sub-block identifier list may include sub-block identifier information corresponding to at least one model data sub-block that is requested to be downloaded).

It should be additionally noted that the first message may include only information 1 or information 2, and that Table 1 and Table 2 are implementation examples made on the basis that the first message includes both information 1 and information 2. This application is not limited to any one of the foregoing definition manners, that is, the first message may include at least one of information 1 and information 2.

In the first message, information 3 is used to request updating or modifying all data corresponding to the application model; and information 4 is used to request updating or modifying a specified portion of data (a corresponding model data sub-block) corresponding to the application model. A manner of implementing functions corresponding to information 3 and information 4 is similar to the manners of implementing the functions corresponding to information 1 and information 2, that is, information 3 and information 4 may be implemented in the foregoing two manners in Table 1 and Table 2. For specific manners, one may refer to the manners of implementing information 1 and information 2 in Table 1 and Table 2. Details are not described herein again. In addition, the first message may include only information 3 or information 4.

Manners of implementing information 5 to information 10 are described as follows: information 5 is used to request uploading all data corresponding to the application model; and information 8 may be used to request uploading a specified portion of data (a corresponding model data sub-block) corresponding to the application model. A manner of implementing functions corresponding to information 5 and information 8 is similar to the manners of implementing the functions corresponding to information 1 and information 2, that is, information 5 and information 8 may be implemented in the foregoing two manners in Table 1 and Table 2. For specific manners, one may refer to the manners of implementing information 1 and information 2 in Table 1 and Table 2. Details are not described herein again. In addition, the first message may include only information 5 or information 8.

The QoS requirement information may reflect a transmission requirement characteristic (for example, a transmission delay requirement, a transmission throughput requirement, or a transmission bit error rate requirement) of data. Information 6 is supplementary information of information 5, and may provide transmission requirement information corresponding to the application model data to the network device or the second terminal device, thereby beneficial for the network device or the second terminal device to configure a corresponding resource for transmitting the application model data. For example, the first terminal device requests uploading data corresponding to an application model 1, and notifies, at the same time, the network device or the second terminal device that a QoS requirement corresponding to the data of the application model 1 is very high. In this case, the network device or the second terminal device may configure, for the first terminal device, a resource for transmitting the data of the application model 1 by using a retransmission mechanism, to ensure transmission reliability of the data of the application model 1. In another example, the first terminal device requests uploading data corresponding to an application model 2, and notifies, at the same time, the network device or the second terminal device that a QoS requirement corresponding to the data of the application model 2 is relatively low. In this case, the network device or the second terminal device may configure, for the first terminal device, a resource for transmitting the data of the application model 2, without using a retransmission mechanism. Because the QoS requirement corresponding to the data of the application model 2 is relatively low, a transmission requirement of the model can be satisfied without using any retransmission mechanism.

Information 9 is supplementary information of information 8, and may provide transmission requirement information corresponding to the application model data sub-block to the network device or the second terminal device, thereby being beneficial for the network device or the second terminal device to configure a resource for transmitting the application model data sub-block. For data corresponding to one application model, QoS requirements of different model data sub-blocks may be different. For example, model structure module data may be more important than other module data. In this case, a QoS requirement of the model structure module data may be very high. Therefore, a transmission manner having relatively high reliability may be used as far as possible for a corresponding transmission resource. For other module data, because a QoS requirement of the data is generally relatively low, a transmission manner with appropriately reduced reliability may also be considered (although the transmission reliability is reduced, the QoS requirement is still satisfied). After all, a transmission manner with low reliability generally has a higher transmission rate than a transmission manner with high reliability (because frequent retransmission is not required).

Configuration granularities of QoS requirements in information 6 and information 9 include any one of the following configuration granularities:
a configuration granularity of one application model identifier, for example, all data corresponding to one application model shares one QoS requirement;
a configuration granularity of one application model sub-block identifier, for example, data corresponding to one application model sub-block shares one QoS requirement; or
a configuration granularity of one application model sub-block identifier group, for example, data corresponding to one group of application model sub-blocks shares one QoS requirement.

Similarly, information 7 is supplementary information of information 5, and may be used to notify the network device or the second terminal device of a size of model data that needs to be uploaded. Notifying the network device or the second terminal device of the size of the model data that needs to be uploaded is beneficial for the network device or the second terminal device to allocate data transmission resources reasonably, and thus facilitates final check of the model data, to verify transmission security.

Similarly, information 10 is supplementary information of information 8, and may be used to notify the network device or the second terminal device of a size of a model data sub-block corresponding to model data that needs to be uploaded. A function of information 10 is similar to that of information 7. Details are not described herein again.

Manners of implementing information 11 and information 12 are described as follows: information 11 is used to request deleting all data corresponding to the application model; and information 12 is used to request deleting a specified portion of data (a corresponding model data sub-block) corresponding to the application model. A manner of implementing functions corresponding to information 11 and information 12 is similar to the manners of implementing the functions corresponding to information 1 and information 2, that is, information 11 and information 12 may be implemented in the foregoing two manners in Table 1 and Table 2. For specific manners, one may refer to the manners of implementing information 1 and information 2 in Table 1 and Table 2. Details are not described herein again. In addition, the first message may include only information 11 or information 12.

It should be noted that, the reason why information 1 to information 4, information 11, and information 12 in the first message are not associated with corresponding QoS requirements and data size indication information is that QoS requirement information and data size indication information are generally provided by a data sender. If the first terminal device serves as a data receiver, the first terminal device is unnecessary to provide such information to the data sender (the network device or the second terminal device).

### Example 3

In this example, the second message in step 5 in FIG. 3 may include at least one of the following information:
model identifier information corresponding to at least one application model that is allowed to be downloaded or added;
sub-block identifier information of a model data sub-block corresponding to at least one application model that is allowed to be downloaded or added;
model identifier information corresponding to at least one application model that is allowed to be updated or modified;
sub-block identifier information of a model data sub-block corresponding to at least one application model that is allowed to be updated or modified;
model identifier information corresponding to at least one application model that is allowed to be uploaded;
sub-block identifier information of a model data sub-block corresponding to at least one application model that is allowed to be uploaded;
model identifier information corresponding to at least one application model that is allowed to be deleted;
sub-block identifier information of a model data sub-block corresponding to at least one application model that is allowed to be deleted;
model identifier information corresponding to at least one application model that is not allowed to be downloaded or added;
sub-block identifier information of a model data sub-block corresponding to at least one application model that is not allowed to be downloaded or added;
model identifier information corresponding to at least one application model that is not allowed to be updated or modified;
sub-block identifier information of a model data sub-block corresponding to at least one application model that is not allowed to be updated or modified;
model identifier information corresponding to at least one application model that is not allowed to be uploaded;
sub-block identifier information of a model data sub-block corresponding to at least one application model that is not allowed to be uploaded;
model identifier information corresponding to at least one application model that is not allowed to be deleted; or
sub-block identifier information of a model data sub-block corresponding to at least one application model that is not allowed to be deleted.

In some implementations, the second message may include a NAS message, an AS message, or an application model operation-specific control message.

The AS message may include any one of the following messages: an RRC message, a MAC CE message, or a downlink control information (DCI) message.

The foregoing application model operation-specific control message may be a message specifically defined for the application model, and may be used to carry control information related to performing an application model operation.

The second message may serve as a response message of the first message. The second message is an optional message. In an implementation, the second message does not exist. In this case, the network device or the second terminal device directly configures a model data transmission resource for the first terminal device by performing step 6a-1 in FIG. 3. Because the model data transmission resource is associated with model data that needs to be transmitted, the model data transmission resource itself may implicitly notify the first terminal device of model data that is allowed to be transmitted and model data that is not allowed to be transmitted, thereby implicitly implementing a notification function of the foregoing second message. In another implementation, the second message exists, includes at least one of the foregoing information, and notifies the first terminal device of model data that is allowed to be transmitted and model data that is not allowed to be transmitted. This manner is an explicit notification manner. In still another implementation, the second message exists but is used only to notify the first terminal device whether the first message has been received successfully. By default, the network device or the second terminal device needs to accept all requests included in the first message transmitted by the first terminal device. None of the foregoing implementations is limited in this application.

### Example 4

As shown in step 6a-1 in FIG. 3, the first terminal device receives an application model data transmission configuration message transmitted by the network device or the second terminal device, where the application model data transmission configuration message is used to determine resource configuration information for transmitting the corresponding application model data.

For example, the resource configuration information for transmitting the corresponding application model data may include configuration information of each communications sub-layer of a data plane protocol stack. The communications sub-layer may include at least one of the following:
a model data adaptation layer, an SDAP layer, a PDCP layer, a BAP layer, an RLC layer, a MAC layer, or a physical (PHY) layer.

The model data adaptation layer may be configured to perform special processing on the model data, for example, perform an operation, such as partitioning, reassembly, or retransmission, on the model data.

In an implementation, a terminal device (for example, the first terminal device in FIG. 3) forwards content of the first message to a core network device or an application model control device through an access network device. After the core network device or the application model control device agrees to establish a model data transmission session for the terminal device, the core network device or the application model control device instructs the access network device to establish model data transmission context for the terminal device, and then the access network device configures, for the terminal device, the resource configuration information for transmitting the application model data.

In another implementation, a terminal device (for example, the first terminal device in FIG. 3) directly transmits content of the first message to an access network device. The access network device establishes a model data transmission session for the terminal device, and configures, for the terminal device via a reconfiguration process, the resource configuration information for transmitting the application model data.

In still another implementation, a terminal device (for example, the first terminal device in FIG. 3) directly transmits content of the first message to an application model control device. The application model control device establishes a model data transmission session for the terminal device, and configures, for the terminal device via a reconfiguration process, the resource configuration information for transmitting the application model data.

In addition, a hybrid manner of the foregoing three implementations may also be used. For example, different model data may be requested in different manners.

For all the above implementations, model data may be stored in any one of the following manners:
the model data is all stored in the core network device;
the model data is all stored in the access network device;
the model data is all stored in the application model control device; or
a portion of the model data is stored in the core network device, and the other portion of the model data is stored in the access network device.

As shown in step 6a-2 in FIG. 3, the first terminal device receives, based on the resource configuration information included in the application model data transmission configuration message, application model data transmitted by the network device or the second terminal device. Then, the first terminal device may reassemble the received application model data. For example, the first terminal device reassembles the received application model data through a NAS, a PDCP layer, an SDAP layer, or a protocol layer dedicated to reassembly of the application model data.

Further, after the first terminal device reassembles the received application model data, the method further includes:
transferring reassembled application model data to an application model data management module; or transferring reassembled application model data to a corresponding function module according to a preset rule.

In an implementation, the preset rule may include any one of the following:
the reassembled application model data is transferred to the corresponding function module based on model identifier information corresponding to the application model data;
the reassembled application model data is transferred to the corresponding function module based on route indication information included in the application model data; or
the reassembled application model data is transferred to the corresponding function module based on model identifier information corresponding to the application model data and route indication information included in the application model data.

For example, the foregoing function module may include any one of the following: an application layer, the NAS, an RRC layer, the SDAP layer, the PDCP layer, an RLC layer, a MAC layer, a BAP layer, or a physical layer.

### Example 5

As shown in step 6b in FIG. 3, the first terminal device receives a control message including the application model data and transmitted by the network device or the second terminal device. The control message includes at least one of the following:
the application model data;
model identifier information corresponding to a first application model to which the application model data belongs;
a sequence number of the application model data in the first application model;
sub-block identifier information corresponding to a first model data sub-block in a first application model to which the application model data belongs;
a sequence number of the application model data in the first model data sub-block;
control message indication information, where the control message indication information is used to indicate whether a current control message is a last segment of a control message; or
a control message segment sequence number, where the control message segment sequence number is used to indicate a segment sequence number of a current control message in a control message.

In the foregoing manner, an application model or a model data sub-block in an application model may be divided into a plurality of segments in embodiments of this application, where each segment is transmitted via one control message. In this way, the network device or the second terminal device may transmit a plurality of segments of a same application model or a same model data sub-block in an application model to the first terminal device respectively via a plurality of control messages. Each control message carries information, such as a sequence number, of a corresponding segment, so that after receiving the plurality of control messages, the first terminal device can combine the segments to form the application model or the model data sub-block, that is, the first device may reassemble, based on content of the control message, the application model data that is received via a plurality of control messages.

For example, generally, a volume of data that can be carried in a control message is relatively small, and a volume of data that can be carried in an application model is relatively large. The network device divides the application model 1 into 100 pieces of data (namely, 100 application model data sub-blocks), and transmits the 100 pieces of application model data to the first terminal device via 100 control messages, where each control message further includes model identifier information (namely, the application model 1) corresponding to an application model to which the application model data belongs, and a sequence number of the application model data in the application model 1. After receiving the control information, the first terminal device may reassemble, based on the model identifier information and the sequence number that are carried in the control messages, the 100 application model data sub-blocks of the application model 1, to obtain the application model 1. For another example, each control message further includes: control message indication information that is used to indicate whether a current control message is a last segment of a control message, and a control message segment sequence number that is used to indicate a segment sequence number of the current control message in the control message. Based on the information, after the control information is received, the first terminal device can reassemble application model data that is in the control information and belongs to a same application model.

In some implementations, the process of reassembling, by the first device based on content of the control message, the application model data that is received via a plurality of control messages includes:
reassembling, by the first device, the received application model data through a NAS, an RRC layer, or a protocol layer dedicated to reassembly of the application model data.

For example, the control message may include a NAS message, an RRC message, or a control message dedicated to transmission of the application model data.

Each control message may include a plurality of types of application model data or include only one type of application model data.

Further, after the first terminal device reassembles the received application model data, the method may further include: transferring reassembled application model data to an application model data management module; or transferring reassembled application model data to a corresponding function module according to a preset rule. For the preset rule and the function module, one may refer to related content in Example 4. Details are not described herein again.

Example 4 and Example 5 describe two different manners of transmitting the application model data. In embodiments of this application, the application model data may be transmitted in the manner described in Example 4 or Example 5, or may be transmitted by combining the foregoing two manners.

### Example 6

As shown in step 3a-1 in FIG. 3, before transmitting the first message, the first terminal device may transmit a third message, where the third message is used to request performing an operation related to registration of the application model data, and/or used to request obtaining application model data format control information.

The third message may include at least one of the following information:
model identifier information corresponding to at least one application model that is requested to be registered;
model identifier information corresponding to at least one application model whose registration is requested to be updated;
model identifier information corresponding to at least one application model that is requested to be de-registered; or
indication information that requests obtaining application model data format control information.

In some implementations, the third message may include a NAS message, an AS message, or an application model operation-specific control message.

The AS message may include any one of the following messages: an RRC message, a MAC CE message, or a UCI message.

The foregoing application model operation-specific control message may be a message specifically defined for the application model, and may be used to carry control information related to performing an application model operation.

The third message is an optional message. If the third message does not exist, the first terminal device is unnecessary to perform an additional operation (that is, is unnecessary to perform a model registration operation and/or an operation for request obtaining model data format control information) before transmitting the first message.

Defining the third message can facilitate model data management. For example, a model data transmit end is a network device, and a model data receive end is a terminal device. For the model data transmit end, transmission of model data will occupy a network device resource; and before transmission of the model data, whether the terminal device is qualified for obtaining the model data may be determined based on a third message. A charging policy of the model data transmit end is also one of reasons causing a registration process. For example, after receiving the third message transmitted by the terminal device, the network device may determine, by checking user subscription information stored on a network device side, whether the terminal device is qualified for downloading corresponding application model data; and notify the terminal device of a qualification verifying result via a fourth message (described below). For a model data request end (the receive end), the terminal device may determine, via the third message, whether the network device supports downloading of the corresponding application model data. This is because not all network devices can support downloading of all types of model data. For example, when the network device does not support downloading of the data of the application model 1, even if subscription information of the terminal device indicates that the terminal device is allowed to download the data of the model 1, the network device rejects a request that is for downloading or registering the data of the model 1 and is transmitted via the third message.

The foregoing operation related to registration of the application model data includes at least one of the following operations: registering the application model data, updating registration of the application model data, and de-registering the application model data. If the terminal device expects to register an application model that has not been registered previously, the third message may include model identifier information corresponding to at least one application model that is requested to be registered. If the terminal device expects to change an existing application model registration result, the third message may include model identifier information corresponding to at least one application model whose registration is requested to be updated. If the terminal device expects to perform a de-registration operation (a registration canceling operation) on an application model that has been registered previously, the third message may include model identifier information corresponding to at least one application model that is requested to be de-registered.

In addition, the foregoing function, corresponding to the third message, of registering application model data can not only determine whether the model data can be downloaded, but also determine a format in which the model data is downloaded. For example, the third message may be further used to request obtaining the application model data format control information. Content included in the application model data format control information is described below in detail. The application model data format control information may be obtained by the following two manners.

Manner 1: the application model data format control information is obtained via dedicated-signalling interaction between the terminal device and the network device.

In an implementation, the third message transmitted by the terminal device includes the indication information that requests obtaining application model data format control information. If the third message requests registering more than one application model, these application models that are requested to be registered may share one piece of indication information for obtaining application model data format control information, where the indication information may indicate that the terminal device requests obtaining application model data format control information corresponding to each application model that is requested to be registered. In another implementation, one application model or a group of application models requested to be registered is associated with one piece of independent indication information for obtaining application model data format control information. In this implementation, higher flexibility and a finer granularity can be achieved. Not all application models that are requested to be registered need to obtain application model data format control information. If the terminal device has obtained the information for an application model from a same network device, the terminal device may choose not to request obtaining the corresponding application model data format control information again. After successfully receiving a registration request (including the indication information that requests obtaining application model data format control information) included in the third message, the network device may provide, via the fourth message, the terminal device with application model data format control information corresponding to an application model that has been registered successfully, for the indication information defined in any manner descried above.

In still another implementation, the third message transmitted by the terminal device does not include the indication information that requests obtaining application model data format control information. It is by default in a protocol that after successfully receiving a registration request included in the third message, the network device needs to provide, via the fourth message, the terminal device with application model data format control information corresponding to an application model that has been registered successfully.

Manner 2: the application model data format control information is obtained in a pre-configuration manner or a default manner.

Examples of the pre-configuration manner are as follows. In an example, if the first terminal device prepares to download application model data 1 from the second terminal device, the first terminal device has obtained, via a network device registration process, application model data format control information corresponding to the application model data 1 before communicating with the second terminal device. In this case, it may be considered that the application model data format control information corresponding to the application model data 1 is configured by the network device for the first terminal device via a pre-configuration process.

In another example, if the first terminal device belongs to a customized device (for example, a factory environment) of a network, corresponding application model data format control information may be configured for the first terminal device in a delivery configuration manner. This configuration manner may also be considered as a pre-configuration manner.

Examples of the default manner are as follows. For example, it is specified directly in a protocol that the application model data 1 is divided into three data sub-blocks whose identifiers are 00, 01, and 10, respectively. In this case, the first terminal device may obtain corresponding application model data format control information according to a default rule in the protocol.

In some implementations, if both the foregoing two manners are defined, a use priority may be specified. In an example, a priority of model data format control information obtained in a dedicated-signalling interaction manner (manner 1) is always higher than a priority of model data format control information obtained in manner 2. In other words, in a case that the network device or the second terminal device has configured model data format control information for the first terminal device in manner 1, even if model data format control information of a corresponding model has also been obtained in manner 2, the first terminal device preferentially uses the model data format control information obtained in manner 1. In another example, model data on which the first terminal device focuses includes only model data format control information obtained in manner 2 (no model data format control information of any model is obtained in manner 1, or although model data format control information of some models is obtained in manner 1, no model data format control information corresponding to a model on which the first terminal device focuses is obtained in manner 1), the first terminal device may use, based on the priority information, the model data format control information obtained in manner 2.

### Example 7

As shown in step 3a-2 in FIG. 3, before transmitting the first message, the first terminal device may receive a fourth message, where the fourth message includes at least one of the following information:
information field 1: model identifier information corresponding to at least one application model that has been registered successfully;
information field 2: model data format control information corresponding to at least one application model that has been registered successfully;
information field 3: operation condition control information corresponding to at least one application model that has been registered successfully;
information field 4: model identifier information corresponding to at least one application model that fails to be registered;
information field 5: failure cause information corresponding to at least one application model that fails to be registered;
information field 6: model identifier information corresponding to at least one application model whose registration has been updated successfully;
information field 7: model data format control information corresponding to at least one application model whose registration has been updated successfully;
information field 8: operation condition control information corresponding to at least one application model whose registration has been updated successfully;
information field 9: model identifier information corresponding to at least one application model whose registration fails to be updated;
information field 10: failure cause information corresponding to at least one application model whose registration fails to be updated;
information field 11: model identifier information corresponding to at least one application model that has been de-registered successfully;
information field 12: model identifier information corresponding to at least one application model that fails to be de-registered; or
information field 13: failure cause information corresponding to at least one application model that fails to be de-registered.

In some implementations, the fourth message may include a NAS message, an AS message, or an application model operation-specific control message.

The AS message may include any one of the following messages: an RRC message, a MAC CE message, or a DCI message.

The foregoing application model operation-specific control message may be a message specifically defined for the application model, and may be used to carry control information related to performing an application model operation.

In some implementations, the fourth message is a successful reception acknowledgment message of the foregoing third message, that is, the fourth message may not carry any one of the information field 1 to the information field 13, and merely serves as a feedback message for successful reception of the third message. In this case, the network device or the second terminal device accepts, by default, all information of the third message transmitted by the first terminal device.

In some other implementations, the third message does not exist, and only the fourth message exists. In this case, the fourth message may be considered as a configuration message actively triggered by the network device or the second terminal device, and the fourth message may include at least one of the information field 1 to the information field 13.

In some other implementations, the fourth message is a response message of the foregoing third message. In this case, the fourth message may include at least one of the information field 1 to the information field 13.

The following describes content of the fourth message in detail, where the information field 2, the information field 3, the information field 7, and the information field 8 are mainly described.

Although the information field 2 and the information field 7 correspond to different function parameters, both the information fields are model data format control information corresponding to an application model. The model data format control information includes at least one of the following information:
sub-field information 1: model QoS requirement information corresponding to an application model;
sub-field information 2: model data size indication information corresponding to an application model;
sub-field information 3: model check control information corresponding to an application model;
sub-field information 4: model transmission security-related control information corresponding to an application model; or
sub-field information 5: model data block control information corresponding to an application model.

The QoS requirement information in the sub-field information 1 may reflect a transmission requirement feature of data, for example, a transmission delay requirement, a transmission throughput requirement, or a transmission bit error rate requirement. The sub-field information 2 may reflect a model data size, to facilitate an operation such as model data resource management, data retransmission management, or data check management. The sub-field information 3 may be used to check corresponding model data, where the check control information may include information such as a check algorithm or a check sequence. The sub-field information 4 may be used to control model data transmission security, and may correspond to operations such as model data integrity protection and encryption/decryption protection. The sub-field information 5 may be used to provide model data block control information. Because some model data is divided into multiple portions, model data block control information corresponding to an application model may include at least one of the following information:
information about a total quantity of model data blocks corresponding to one application model;
identifier information corresponding to each model data sub-block;
QoS requirement information corresponding to each model data sub-block;
data size indication information corresponding to each model data sub-block;
check control information corresponding to each model data sub-block; or
model transmission security-related control information corresponding to each model data sub-block.

Meanings of sub-fields in the model data block control information corresponding to the application model are similar to the meanings of the sub-field information 1 to the sub-field information 4. Details are not described herein again.

The information field 3 and the information field 8 correspond to different function parameters, but both the information fields 3 and 8 are condition control information of an application model-related operation. If an application model has been registered successfully or registration of an application model has been updated successfully, it can only indicate that a corresponding application model-related operation is supported in a current network region. Once the terminal device moves out of the current network region, the application model-related operation may fail to be performed. In a case that the terminal device has condition control information of an application model-related operation, each time before initiating the application model-related operation, the terminal device can compare information provided by a current network with the condition control information of the application model-related operation stored in the terminal device. When a comparison result shows that corresponding information meets a requirement or is matched, the terminal device executes the application model-related operation; otherwise, the terminal device does not perform the application model-related operation.

In some implementations, the foregoing condition control information of the application model-related operation includes valid use region control information and/or valid use time control information that is associated with the application model-related operation.

### Example 8

In this example, the first terminal device performs capability interaction with the network device or the second terminal device.

For example, as shown by step 1 in FIG. 3, the first terminal device further transmits first capability indication information to the network device or the second terminal device, where the first capability indication information is used to indicate whether the first terminal device is capable of supporting an application model-related operation.

For another example, as shown by step 2-1 in FIG. 3, the first terminal device further receives second capability indication information transmitted by the network device or the second terminal device, where the second capability indication information is used to notify the first terminal device whether the network device or the second terminal device is capable of supporting an application model-related operation.

Steps of transmitting the first capability indication information by the first terminal device and receiving the second capability indication information by the first terminal are both optional steps. Because the application model-related operation may include one or more operations, the first capability indication information or the second capability indication information can be implemented by at least the following two manners.

Implementation 1: all application model-related operations share one piece of common capability indication information. In this implementation, all or none of these application model-related operations are supported.

Implementation 2: one application model-related operation or a group of application model-related operations corresponds to one piece of capability indication information. In this implementation, some of application model-related operations are supported, and the other application model-related operations are not supported.

In addition, in some implementations, as shown in step 2-2 in FIG. 3, for example, the first terminal device receives on/off indication information from the network device or the second terminal device, where the on/off indication information is used to indicate whether the first terminal device is allowed to perform an application model-related operation.

In some implementations, the application model-related operation includes at least one of the following operations:
downloading the application model data or adding the application model data;
updating the application model data or modifying the application model data;
uploading the application model data;
deleting the application model data;
registering the application model data;
updating registration of the application model data;
de-registering the application model data; or
requesting obtaining format control information of the application model data.

In summary, it can be learned that model data can be managed and controlled according to embodiments of this application. In embodiments of this application, in one aspect, in the background of valid authorization (for example, registration before use), a terminal device may implement operations such as downloading, adding, updating, modifying, uploading, and deleting one or more types of model data, to prevent an illegal user from performing a model data-related operation. In another aspect, effective transmission of model data can be implemented more flexibly by means of partitioning of the model data and QoS requirement management at a granularity of a data block. For example, a terminal applies for downloading some data blocks of the model data when the terminal is busy processing a service, and applies for downloading remaining data blocks of the model data when the terminal is relatively idle. Because the model data is managed by block, use of the model data after reassembly is not affected even if a time interval between the two times of downloading is long. Particularly, when a data volume of the model data is relatively large, the block-based download mode has a more significant advantage, and is more flexible than a mode in which the model data is completely downloaded once. In addition, due to the QoS requirement management at a granularity of a data block, a data transmit end may be guided to select an appropriate transmission mode (for example, a retransmission-containing mode, a partial retransmission mode, or a retransmission-free mode) based on the importance of a model data sub-block, thereby being beneficial to improve transmission efficiency of the model data.

FIG. 4 is a schematic flowchart of a communication method 400 according to an embodiment of this application. Optionally, the method may be applied to the system shown in FIG. 1, but is not limited thereto. The method includes at least step S410.

In step S410, a second device receives a first message from a first device, where the first message is used to request at least one of the following operations:
downloading application model data or adding application model data;
updating application model data or modifying application model data;
uploading application model data; or
deleting application model data.

In some implementations, the first message includes at least one of the following:
model identifier information corresponding to at least one application model that is requested to be downloaded or added;
sub-block identifier information of a model data sub-block corresponding to at least one application model that is requested to be downloaded or added;
model identifier information corresponding to at least one application model that is requested to be updated or modified;
sub-block identifier information of a model data sub-block corresponding to at least one application model that is requested to be updated or modified;
model identifier information corresponding to at least one application model that is requested to be uploaded;
model QoS requirement information corresponding to at least one application model that is requested to be uploaded;
model data size indication information corresponding to at least one application model that is requested to be uploaded;
sub-block identifier information of a model data sub-block corresponding to at least one application model that is requested to be uploaded;
QoS requirement information of a model data sub-block corresponding to at least one application model that is requested to be uploaded;
sub-block data size indication information of a model data sub-block corresponding to at least one application model that is requested to be uploaded;
model identifier information corresponding to at least one application model that is requested to be deleted; or
sub-block identifier information of a model data sub-block corresponding to at least one application model that is requested to be deleted.

In some implementations, the first message includes a NAS message, an AS message, or an application model operation-specific control message.

In some implementations, the method further includes: transmitting, by the second device, a second message to the first device, where the second message includes at least one of the following:
model identifier information corresponding to at least one application model that is allowed to be downloaded or added;
sub-block identifier information of a model data sub-block corresponding to at least one application model that is allowed to be downloaded or added;
model identifier information corresponding to at least one application model that is allowed to be updated or modified;
sub-block identifier information of a model data sub-block corresponding to at least one application model that is allowed to be updated or modified;
model identifier information corresponding to at least one application model that is allowed to be uploaded;
sub-block identifier information of a model data sub-block corresponding to at least one application model that is allowed to be uploaded;
model identifier information corresponding to at least one application model that is allowed to be deleted;
sub-block identifier information of a model data sub-block corresponding to at least one application model that is allowed to be deleted;
model identifier information corresponding to at least one application model that is not allowed to be downloaded or added;
sub-block identifier information of a model data sub-block corresponding to at least one application model that is not allowed to be downloaded or added;
model identifier information corresponding to at least one application model that is not allowed to be updated or modified;
sub-block identifier information of a model data sub-block corresponding to at least one application model that is not allowed to be updated or modified;
model identifier information corresponding to at least one application model that is not allowed to be uploaded;
sub-block identifier information of a model data sub-block corresponding to at least one application model that is not allowed to be uploaded;
model identifier information corresponding to at least one application model that is not allowed to be deleted; or
sub-block identifier information of a model data sub-block corresponding to at least one application model that is not allowed to be deleted.

In some implementations, the second message includes a NAS message, an AS message, or an application model operation-specific control message.

In some implementations, the method further includes: transmitting, by the second device, an application model data transmission configuration message to the first device, where the application model data transmission configuration message is used to determine resource configuration information for transmitting the corresponding application model data.

In some implementations, the method further includes: transmitting, by the second device to the first device, a control message including the application model data, where the control message includes at least one of the following:
the application model data;
model identifier information corresponding to a first application model to which the application model data belongs;
a sequence number of the application model data in the first application model;
sub-block identifier information corresponding to a first model data sub-block in a first application model to which the application model data belongs;
a sequence number of the application model data in the first model data sub-block;
control message indication information, where the control message indication information is used to indicate whether a current control message is a last segment of a control message; or
a control message segment sequence number, where the control message segment sequence number is used to indicate a segment sequence number of a current control message in a control message.

In some implementations, the control message includes a NAS message, a radio resource control RRC message, or a control message dedicated to transmission of the application model data.

In some implementations, the method further includes: receiving, by the second device, a third message from the first device, where the third message is used to request performing an operation related to registration of the application model data, and/or used to request obtaining model data format control information.

In some implementations, the third message includes at least one of the following:
model identifier information corresponding to at least one application model that is requested to be registered;
model identifier information corresponding to at least one application model whose registration is requested to be updated;
model identifier information corresponding to at least one application model that is requested to be de-registered; or
indication information that requests obtaining the model data format control information.

In some implementations, the third message includes a NAS message, an AS message, or an application model operation-specific control message.

In some implementations, the method further includes: transmitting, by the second device, a fourth message to the first device, where the fourth message includes at least one of the following:
model identifier information corresponding to at least one application model that has been registered successfully;
model data format control information corresponding to at least one application model that has been registered successfully;
operation condition control information corresponding to at least one application model that has been registered successfully;
model identifier information corresponding to at least one application model that fails to be registered;
failure cause information corresponding to at least one application model that fails to be registered;
model identifier information corresponding to at least one application model whose registration has been updated successfully;
model data format control information corresponding to at least one application model whose registration has been updated successfully;
operation condition control information corresponding to at least one application model whose registration has been updated successfully;
model identifier information corresponding to at least one application model whose registration fails to be updated;
failure cause information corresponding to at least one application model whose registration fails to be updated;
model identifier information corresponding to at least one application model that has been de-registered successfully;
model identifier information corresponding to at least one application model that fails to be de-registered; or
failure cause information corresponding to at least one application model that fails to be de-registered.

In some implementations, the fourth message includes a NAS message, an AS message, or an application model operation-specific control message.

In some implementations, the model data format control information includes at least one of the following:
model QoS requirement information corresponding to an application model;
model data size indication information corresponding to an application model;
model check control information corresponding to an application model;
model transmission security-related control information corresponding to an application model; or
model data block control information corresponding to an application model.

In some implementations, the model data block control information corresponding to an application model includes at least one of the following:
a quantity of model data sub-blocks corresponding to one application model;
sub-block identifier information corresponding to each model data sub-block;
QoS requirement information corresponding to each model data sub-block;
data size indication information corresponding to each model data sub-block;
check control information corresponding to each model data sub-block; or
model transmission security-related control information corresponding to each model data sub-block.

In some implementations, the method further includes: receiving, by the second device, first capability indication information from the first device, where the first capability indication information is used to indicate whether the first device is capable of supporting an application model-related operation.

In some implementations, the method further includes: transmitting, by the second device, second capability indication information to the first device, where the second capability indication information indicates whether the second device is capable of supporting an application model-related operation.

In some implementations, the method further includes: transmitting, by the second device, on/off indication information to the first device, where the on/off indication information is used to indicate whether the first device is allowed to perform an application model-related operation.

In some implementations, the application model-related operation includes at least one of the following:
downloading the application model data or adding the application model data;
updating the application model data or modifying the application model data;
uploading the application model data;
deleting the application model data;
registering the application model data;
updating registration of the application model data;
de-registering the application model data; or
requesting obtaining format control information of the application model data.

In some implementations, a data module corresponding to the application model data includes at least one of the following:
a model input data module, a model output data module, a model training data module, a model inference data module, a model storage data module, a model computing data module, a model structure data module, or a model coordination control data module.

In some implementations, an application model corresponding to the application model data includes at least one of the following:
an AI model, an ML model, a supercomputing model, a neuron-like model, an authentication model, an encryption and decryption model, or a self-optimization model.
   In some implementations, the first device includes a terminal device.

In some implementations, the second device includes a network device or a terminal device.

In some implementations, the network device includes an access network device, a core network device, or an application model control device.

For a specific example of performing the method 400 by the second device in this embodiment, one may refer to related description about the second device in the foregoing method 200. For brevity, details are not described herein again.

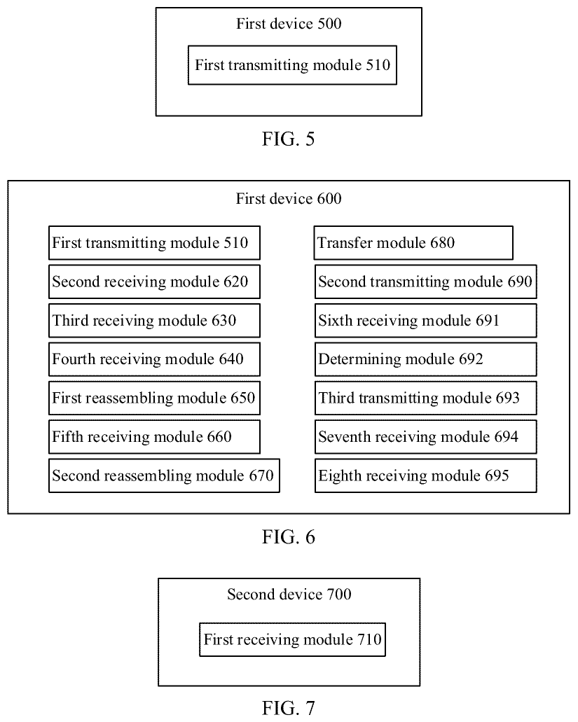

FIG. 5 is a schematic block diagram of a first device 500 according to an embodiment of this application. The first device 500 may include:
a first transmitting module 510, configured to transmit a first message, where the first message is used to request at least one of the following operations:
downloading application model data or adding application model data;
updating application model data or modifying application model data;
uploading application model data; or
deleting application model data.

In some implementations, the first message includes at least one of the following:
model identifier information corresponding to at least one application model that is requested to be downloaded or added;
sub-block identifier information of a model data sub-block corresponding to at least one application model that is requested to be downloaded or added;
model identifier information corresponding to at least one application model that is requested to be updated or modified;
sub-block identifier information of a model data sub-block corresponding to at least one application model that is requested to be updated or modified;
model identifier information corresponding to at least one application model that is requested to be uploaded;
model quality of service QoS requirement information corresponding to at least one application model that is requested to be uploaded;
model data size indication information corresponding to at least one application model that is requested to be uploaded;
sub-block identifier information of a model data sub-block corresponding to at least one application model that is requested to be uploaded;
QoS requirement information of a model data sub-block corresponding to at least one application model that is requested to be uploaded;
sub-block data size indication information of a model data sub-block corresponding to at least one application model that is requested to be uploaded;
model identifier information corresponding to at least one application model that is requested to be deleted; or
sub-block identifier information of a model data sub-block corresponding to at least one application model that is requested to be deleted.

In some implementations, the first message includes a non-access stratum NAS message, an access stratum AS message, or an application model operation-specific control message.

FIG. 6 is a schematic block diagram of a first device 600 according to an embodiment of this application. As shown in FIG. 6, the first device further includes:
a second receiving module 620, configured to receive a second message from the second device, where the second message includes at least one of the following:
model identifier information corresponding to at least one application model that is allowed to be downloaded or added;
sub-block identifier information of a model data sub-block corresponding to at least one application model that is allowed to be downloaded or added;
model identifier information corresponding to at least one application model that is allowed to be updated or modified;
sub-block identifier information of a model data sub-block corresponding to at least one application model that is allowed to be updated or modified;
model identifier information corresponding to at least one application model that is allowed to be uploaded;
sub-block identifier information of a model data sub-block corresponding to at least one application model that is allowed to be uploaded;
model identifier information corresponding to at least one application model that is allowed to be deleted;
sub-block identifier information of a model data sub-block corresponding to at least one application model that is allowed to be deleted;
model identifier information corresponding to at least one application model that is not allowed to be downloaded or added;
sub-block identifier information of a model data sub-block corresponding to at least one application model that is not allowed to be downloaded or added;
model identifier information corresponding to at least one application model that is not allowed to be updated or modified;
sub-block identifier information of a model data sub-block corresponding to at least one application model that is not allowed to be updated or modified;
model identifier information corresponding to at least one application model that is not allowed to be uploaded;
sub-block identifier information of a model data sub-block corresponding to at least one application model that is not allowed to be uploaded;
model identifier information corresponding to at least one application model that is not allowed to be deleted; or
sub-block identifier information of a model data sub-block corresponding to at least one application model that is not allowed to be deleted.

In some implementations, the second message includes a NAS message, an AS message, or an application model operation-specific control message.

As shown in FIG. 6, in some implementations, the first device further includes:
a third receiving module 630, configured to receive an application model data transmission configuration message from the second device, where the application model data transmission configuration message is used to determine resource configuration information for transmitting the corresponding application model data.

As shown in FIG. 6, in some implementations, the first device further includes:
a fourth receiving module 640, configured to receive the application model data based on the resource configuration information included in the application model data transmission configuration message.

As shown in FIG. 6, in some implementations, the first device further includes:
a first reassembling module 650, configured to reassemble the received application model data.

In some implementations, the reassembling module 650 is configured to reassemble the received application model data through a NAS, a packet data convergence protocol PDCP layer, a service data adaptation protocol SDAP layer, or a protocol layer dedicated to reassembly of the application model data.

As shown in FIG. 6, in some implementations, the first device further includes:
a fifth receiving module 660, configured to receive, from the second device, a control message including the application model data, where the control message includes at least one of the following:
the application model data;
model identifier information corresponding to a first application model to which the application model data belongs;
a sequence number of the application model data in the first application model;
sub-block identifier information corresponding to a first model data sub-block in a first application model to which the application model data belongs;
a sequence number of the application model data in the first model data sub-block;
control message indication information, where the control message indication information is used to indicate whether a current control message is a last segment of a control message; or
a control message segment sequence number, where the control message segment sequence number is used to indicate a segment sequence number of a current control message in a control message.

In some implementations, the control message includes a non-access stratum NAS message, a radio resource control RRC message, or a control message dedicated to transmission of the application model data.

As shown in FIG. 6, in some implementations, the first device further includes:
a first reassembling module 670, configured to reassemble, based on content of the control message, the application model data that is received via a plurality of control messages.

In some implementations, the first reassembling module 670 is configured to reassemble the received application model data through a NAS, an RRC layer, or a protocol layer dedicated to reassembly of the application model data.

As shown in FIG. 6, in some implementations, the first device further includes:
a transfer module 680, configured to: transfer reassembled application model data to an application model data management module; or transfer reassembled application model data to a corresponding function module according to a preset rule.

In some implementations, the preset rule includes any one of the following:
the reassembled application model data is transferred to the corresponding function module based on model identifier information corresponding to the application model data;
the reassembled application model data is transferred to the corresponding function module based on route indication information included in the application model data; or
the reassembled application model data is transferred to the corresponding function module based on model identifier information corresponding to the application model data and route indication information included in the application model data.

In some implementations, the function module includes any one of the following: an application layer, the NAS, an RRC layer, the SDAP layer, the PDCP layer, an RLC layer, a MAC layer, a BAP layer, or a physical layer.

As shown in FIG. 6, in some implementations, the first device further includes:
a second transmitting module 690, configured to transmit a third message to the second device, where the third message is used to request performing an operation related to registration of the application model data, and/or used to request obtaining model data format control information.

In some implementations, the third message includes at least one of the following:
model identifier information corresponding to at least one application model that is requested to be registered;
model identifier information corresponding to at least one application model whose registration is requested to be updated;
model identifier information corresponding to at least one application model that is requested to be de-registered; or
indication information that requests obtaining the model data format control information.

In some implementations, the third message includes a NAS message, an AS message, or an application model operation-specific control message.

As shown in FIG. 6, in some implementations, the first device further includes:
a sixth receiving module 691, configured to receive a fourth message from the second device, where the fourth message includes at least one of the following:
model identifier information corresponding to at least one application model that has been registered successfully;
model data format control information corresponding to at least one application model that has been registered successfully;
operation condition control information corresponding to at least one application model that has been registered successfully;
model identifier information corresponding to at least one application model that fails to be registered;
failure cause information corresponding to at least one application model that fails to be registered;
model identifier information corresponding to at least one application model whose registration has been updated successfully;
model data format control information corresponding to at least one application model whose registration has been updated successfully;
operation condition control information corresponding to at least one application model whose registration has been updated successfully;
model identifier information corresponding to at least one application model whose registration fails to be updated;
failure cause information corresponding to at least one application model whose registration fails to be updated;
model identifier information corresponding to at least one application model that has been de-registered successfully;
model identifier information corresponding to at least one application model that fails to be de-registered; or
failure cause information corresponding to at least one application model that fails to be de-registered.

In some implementations, the fourth message includes a NAS message, an AS message, or an application model operation-specific control message.

As shown in FIG. 6, in some implementations, the first device further includes:
a determining module 692, configured to determine, in a pre-configuration manner or a default manner, model data format control information corresponding to at least one application model.

In some implementations, the model data format control information includes at least one of the following:
model QoS requirement information corresponding to an application model;
model data size indication information corresponding to an application model;
model check control information corresponding to an application model;
model transmission security-related control information corresponding to an application model; or
model data block control information corresponding to an application model.

In some implementations, the model data block control information corresponding to an application model includes at least one of the following:
a quantity of model data sub-blocks corresponding to one application model;
sub-block identifier information corresponding to each model data sub-block;
QoS requirement information corresponding to each model data sub-block;
data size indication information corresponding to each model data sub-block;
check control information corresponding to each model data sub-block; or
model transmission security-related control information corresponding to each model data sub-block.

As shown in FIG. 6, in some implementations, the first device further includes:
a third transmitting module 693, configured to transmit first capability indication information to the second device, where the first capability indication information is used to indicate whether the first device is capable of supporting an application model-related operation.

As shown in FIG. 6, in some implementations, the first device further includes:
a seventh receiving module 694, configured to receive second capability indication information from the second device, where the second capability indication information indicates whether the second device is capable of supporting an application model-related operation.

As shown in FIG. 6, in some implementations, the first device further includes:
an eighth receiving module 695, configured to receive on/off indication information from the second device, where the on/off indication information is used to indicate whether the first device is allowed to perform an application model-related operation.

In some implementations, the application model-related operation includes at least one of the following:
downloading the application model data or adding the application model data;
updating the application model data or modifying the application model data;
uploading the application model data;
deleting the application model data;
registering the application model data;
updating registration of the application model data;
de-registering the application model data; or
requesting obtaining format control information of the application model data.

In some implementations, a data module corresponding to the application model data includes at least one of the following:
a model input data module, a model output data module, a model training data module, a model inference data module, a model storage data module, a model computing data module, a model structure data module, or a model coordination control data module.

In some implementations, an application model corresponding to the application model data includes at least one of the following:
an artificial intelligence AI model, a machine learning ML model, a supercomputing model, a neuron-like model, an authentication model, an encryption and decryption model, or a self-optimization model.

In some implementations, the first device includes a terminal device.

In some implementations, the second device includes a network device or a terminal device.

In some implementations, the network device includes an access network device, a core network device, or an application model control device.

The first device 500 and the first device 600 in these embodiments of this application can implement corresponding functions of the terminal device in the foregoing method embodiments. For procedures, functions, implementations, and beneficial effects corresponding to modules (sub-modules, units, components, or the like) in the first device 500 and the first device 600, one may refer to corresponding descriptions in the foregoing method embodiments. Details are not described herein again. It should be noted that functions of modules (sub-modules, units, components, or the like) in the first device 500 and the first device 600 in these embodiments of this application may be implemented by different modules (sub-modules, units, components, or the like), or may be implemented by a same module (sub-module, unit, component, or the like).

FIG. 7 is a schematic block diagram of a second device 700 according to an embodiment of this application. The second device 700 may include:
a first receiving module 710, configured to receive a first message from a first device, where the first message is used to request at least one of the following operations:
downloading application model data or adding application model data;
updating application model data or modifying application model data;
uploading application model data; or
deleting application model data.

In some implementations, the first message includes at least one of the following:
model identifier information corresponding to at least one application model that is requested to be downloaded or added;
sub-block identifier information of a model data sub-block corresponding to at least one application model that is requested to be downloaded or added;
model identifier information corresponding to at least one application model that is requested to be updated or modified;
sub-block identifier information of a model data sub-block corresponding to at least one application model that is requested to be updated or modified;
model identifier information corresponding to at least one application model that is requested to be uploaded;
QoS requirement information corresponding to at least one application model that is requested to be uploaded;
model data size indication information corresponding to at least one application model that is requested to be uploaded;
sub-block identifier information of a model data sub-block corresponding to at least one application model that is requested to be uploaded;
QoS requirement information of a model data sub-block corresponding to at least one application model that is requested to be uploaded;
sub-block data size indication information of a model data sub-block corresponding to at least one application model that is requested to be uploaded;
model identifier information corresponding to at least one application model that is requested to be deleted; or
sub-block identifier information of a model data sub-block corresponding to at least one application model that is requested to be deleted.

In some implementations, the first message includes a NAS message, an AS message, or an application model operation-specific control message.

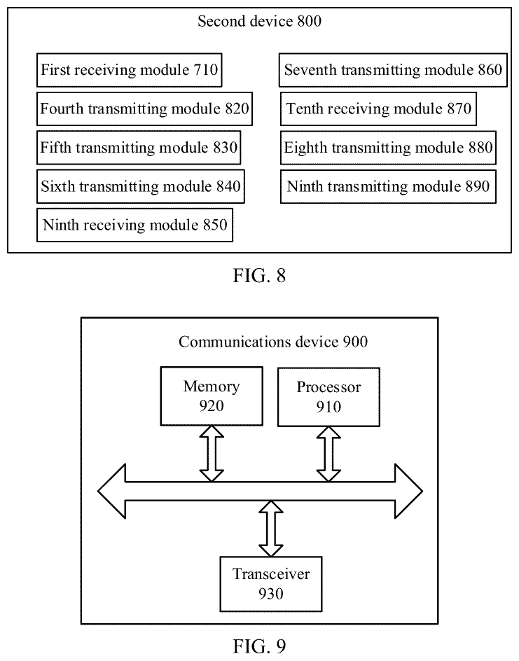

FIG. 8 is a schematic block diagram of a second device 800 according to an embodiment of this application. As shown in FIG. 8, the second device further includes:
a fourth transmitting module 820, configured to transmit a second message to the first device, where the second message includes at least one of the following:
model identifier information corresponding to at least one application model that is allowed to be downloaded or added;
sub-block identifier information of a model data sub-block corresponding to at least one application model that is allowed to be downloaded or added;
model identifier information corresponding to at least one application model that is allowed to be updated or modified;
sub-block identifier information of a model data sub-block corresponding to at least one application model that is allowed to be updated or modified;
model identifier information corresponding to at least one application model that is allowed to be uploaded;
sub-block identifier information of a model data sub-block corresponding to at least one application model that is allowed to be uploaded;
model identifier information corresponding to at least one application model that is allowed to be deleted;
sub-block identifier information of a model data sub-block corresponding to at least one application model that is allowed to be deleted;
model identifier information corresponding to at least one application model that is not allowed to be downloaded or added;
sub-block identifier information of a model data sub-block corresponding to at least one application model that is not allowed to be downloaded or added;
model identifier information corresponding to at least one application model that is not allowed to be updated or modified;
sub-block identifier information of a model data sub-block corresponding to at least one application model that is not allowed to be updated or modified;
model identifier information corresponding to at least one application model that is not allowed to be uploaded;
sub-block identifier information of a model data sub-block corresponding to at least one application model that is not allowed to be uploaded;
model identifier information corresponding to at least one application model that is not allowed to be deleted; or
sub-block identifier information of a model data sub-block corresponding to at least one application model that is not allowed to be deleted.

In some implementations, the second message includes a NAS message, an AS message, or an application model operation-specific control message.

As shown in FIG. 8, in some implementations, the second device further includes:
a fifth transmitting module 830, configured to transmit an application model data transmission configuration message to the first device, where the application model data transmission configuration message is used to determine resource configuration information for transmitting the corresponding application model data.

As shown in FIG. 8, in some implementations, the second device further includes:
a sixth transmitting module 840, configured to transmit, to the first device, a control message including the application model data, where the control message includes at least one of the following:
the application model data;
model identifier information corresponding to a first application model to which the application model data belongs;
a sequence number of the application model data in the first application model;
sub-block identifier information corresponding to a first model data sub-block in a first application model to which the application model data belongs;
a sequence number of the application model data in the first model data sub-block;
control message indication information, where the control message indication information is used to indicate whether a current control message is a last segment of a control message; or
a control message segment sequence number, where the control message segment sequence number is used to indicate a segment sequence number of a current control message in a control message.

In some implementations, the control message includes a NAS message, a radio resource control RRC message, or a control message dedicated to transmission of the application model data.

As shown in FIG. 8, in some implementations, the second device further includes:
a ninth receiving module 850, configured to receive a third message from the first device, where the third message is used to request performing an operation related to registration of the application model data, and/or used to request obtaining model data format control information.

In some implementations, the third message includes at least one of the following:
model identifier information corresponding to at least one application model that is requested to be registered;
model identifier information corresponding to at least one application model whose registration is requested to be updated;
model identifier information corresponding to at least one application model that is requested to be de-registered; or
indication information that requests obtaining the model data format control information.

In some implementations, the third message includes a NAS message, an AS message, or an application model operation-specific control message.

As shown in FIG. 8, in some implementations, the second device further includes:
a seventh transmitting module 860, configured to transmit a fourth message to the first device, where the fourth message includes at least one of the following:
model identifier information corresponding to at least one application model that has been registered successfully;
model data format control information corresponding to at least one application model that has been registered successfully;
operation condition control information corresponding to at least one application model that has been registered successfully;
model identifier information corresponding to at least one application model that fails to be registered;
failure cause information corresponding to at least one application model that fails to be registered;
model identifier information corresponding to at least one application model whose registration has been updated successfully;
model data format control information corresponding to at least one application model whose registration has been updated successfully;
operation condition control information corresponding to at least one application model whose registration has been updated successfully;
model identifier information corresponding to at least one application model whose registration fails to be updated;
failure cause information corresponding to at least one application model whose registration fails to be updated;
model identifier information corresponding to at least one application model that has been de-registered successfully;
model identifier information corresponding to at least one application model that fails to be de-registered; or
failure cause information corresponding to at least one application model that fails to be de-registered.

In some implementations, the fourth message includes a NAS message, an AS message, or an application model operation-specific control message.

In some implementations, the model data format control information includes at least one of the following:
model QoS requirement information corresponding to an application model;
model data size indication information corresponding to an application model;
model check control information corresponding to an application model;
model transmission security-related control information corresponding to an application model; or
model data block control information corresponding to an application model.

In some implementations, the model data block control information corresponding to an application model includes at least one of the following:
a quantity of model data sub-blocks corresponding to one application model;
sub-block identifier information corresponding to each model data sub-block;
QoS requirement information corresponding to each model data sub-block;
data size indication information corresponding to each model data sub-block;
check control information corresponding to each model data sub-block; or
model transmission security-related control information corresponding to each model data sub-block.

As shown in FIG. 8, in some implementations, the second device further includes:
a tenth receiving module 870, configured to receive first capability indication information from the first device, where the first capability indication information is used to indicate whether the first device is capable of supporting an application model-related operation.

As shown in FIG. 8, in some implementations, the second device further includes:
an eighth transmitting module 880, configured to transmit second capability indication information to the first device, where the second capability indication information indicates whether the second device is capable of supporting an application model-related operation.

As shown in FIG. 8, in some implementations, the second device further includes:
a ninth transmitting module 890, configured to transmit on/off indication information to the first device, where the on/off indication information is used to indicate whether the first device is allowed to perform an application model-related operation.

In some implementations, the application model-related operation includes at least one of the following:
downloading the application model data or adding the application model data;
updating the application model data or modifying the application model data;
uploading the application model data;
deleting the application model data;
registering the application model data;
updating registration of the application model data;
de-registering the application model data; or
requesting obtaining format control information of the application model data.

In some implementations, a data module corresponding to the application model data includes at least one of the following:
a model input data module, a model output data module, a model training data module, a model inference data module, a model storage data module, a model computing data module, a model structure data module, or a model coordination control data module.

In some implementations, an application model corresponding to the application model data includes at least one of the following:
an AI model, an ML model, a supercomputing model, a neuron-like model, an authentication model, an encryption and decryption model, or a self-optimization model.

In some implementations, the first device includes a terminal device.

In some implementations, the second device includes a network device or a terminal device.

In some implementations, the network device includes an access network device, a core network device, or an application model control device.

The second device 700 and the second device 800 in these embodiments of this application can implement corresponding functions of the network device in the foregoing method embodiments. For procedures, functions, implementations, and beneficial effects corresponding to modules (sub-modules, units, components, or the like) in the second device 700 and the second device 800, one may refer to corresponding descriptions in the foregoing method embodiments. Details are not described herein again. It should be noted that functions of modules (sub-modules, units, components, or the like) in the second device 700 and the second device 800 in these embodiments of this application may be implemented by different modules (sub-modules, units, components, or the like), or may be implemented by a same module (sub-module, unit, component, or the like).

FIG. 9 is a schematic structural diagram of a communications device 900 according to an embodiment of this application. The communications device 900 includes a processor 910. The processor 910 may invoke a computer program from a memory and run the computer program, to cause the communications device 900 to implement the method described in embodiments of this application.

In an implementation, the communications device 900 may further include a memory 920. The processor 910 may invoke a computer program from the memory 920 and run the computer program, to cause the communications device 900 to implement the method described in embodiments of this application.

The memory 920 may be a separate component independent of the processor 910, or may be integrated into the processor 910.

In an implementation, the communications device 900 may further include a transceiver 930. The processor 910 may control the transceiver 930 to communicate with another device. Specifically, the processor 910 may transmit information or data to the another device, or receive information or data transmitted by the another device.

The transceiver 930 may include a transmitter and a receiver. The transceiver 930 may further include an antenna, and a quantity of antennas may be one or more.

In an implementation, the communications device 900 may be the network device in embodiments of this application, and the communications device 900 may implement corresponding processes implemented by the first device in methods described in embodiments of this application. For brevity, details are not described herein again.

In an implementation, the communications device 900 may be the terminal device in embodiments of this application, and the communications device 900 may implement corresponding processes implemented by the second device in methods described in embodiments of this application. For brevity, details are not described herein again.

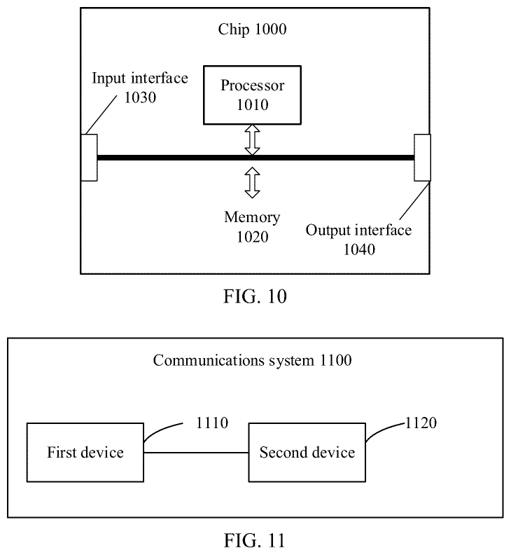

FIG. 10 is a schematic structural diagram of a chip 1000 according to an embodiment of this application. The chip 1000 includes a processor 1010. The processor 1010 may invoke a computer program from a memory and run the computer program, to implement the method described in embodiments of this application.

In an implementation, the chip 1000 may further include a memory 1020. The processor 1010 may invoke a computer program from the memory 1020 and run the computer program, to implement the method executed by the terminal device or the network device in embodiments of this application.

The memory 1020 may be a separate component independent of the processor 1010, or may be integrated into the processor 1010.

In an implementation, the chip 1000 may further include an input interface 1030. The processor 1010 may control the input interface 1030 to communicate with another device or chip, and specifically, may obtain information or data transmitted by the another device or chip.

In an implementation, the chip 1000 may further include an output interface 1040. The processor 1010 may control the output interface 1040 to communicate with another device or chip, and specifically, may output information or data to the another device or chip.

In an implementation, the chip may be applied to the first device in embodiments of this application, and the chip may implement corresponding processes implemented by the first device in methods described in embodiments of this application. For brevity, details are not described herein again.

In an implementation, the chip may be applied to the second device in embodiments of this application, and the chip may implement corresponding processes implemented by the second device in methods described in embodiments of this application. For brevity, details are not described herein again.

Chips applied to the first device and the second device may be a same chip or different chips.

It should be understood that the chip mentioned in embodiments of this application may also be referred to as a system-level chip, a system chip, a chip system, a system-on-chip, or the like.

The processor mentioned above may be a general-purpose processor, a digital signal processor (digital signal processor, DSP), a field programmable gate array (field programmable gate array, FPGA), an application-specific integrated circuit (application specific integrated circuit, ASIC) or another programmable logic device, a transistor logic device, a discrete hardware component, or the like. The general-purpose processor mentioned above may be a microprocessor, or may be any conventional processor or the like.

The memory mentioned above may be a volatile memory or a non-volatile memory, or may include both a volatile memory and a non-volatile memory. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM).

It should be understood that, by way of example rather than limitative description, for example, the memory in embodiments of this application may alternatively be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synch link DRAM, SLDRAM), a direct Rambus random access memory (Direct Rambus RAM, DR RAM), or the like. In other words, the memory in embodiments of this application includes but is not limited to these memories and any other proper types of memories.

FIG. 11 is a schematic block diagram of a communications system 1100 according to an embodiment of this application. The communications system 1100 includes a first device 1110 and a second device 1120.

The first device 1110 may be configured to implement corresponding functions implemented by the first device described in the foregoing method, and the second device 1220 may be configured to implement corresponding functions implemented by the second device described in the foregoing method. For brevity, details are not described herein again.

Some or all of the foregoing embodiments may be implemented by using software, hardware, firmware, or any combination thereof. When software is used to implement the embodiments, some or all of the embodiments may be implemented in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL) manner or a wireless (such as infrared, wireless, and microwave) manner. The computer-readable storage medium may be any available medium accessible by a computer or a data storage device such as a server or a data center that integrates one or more available media. The available medium may be a magnetic medium (for example, a floppy disk, a hard disk, or a magnetic tape), an optical medium (for example, a DVD), a semiconductor medium (for example, a solid state disk (SSD), or the like.

It should be understood that, in embodiments of this application, sequence numbers of the foregoing processes do not mean execution sequences. The execution sequences of the processes should be determined according to functions and internal logic of the processes, and should not be construed as any limitation on the implementation processes of embodiments of this application.

It may be clearly understood by persons skilled in the art that, for convenient and brief description, for a detailed working process of the foregoing system, apparatus, and unit, reference may be made to corresponding processes in the foregoing method embodiments, and details are not described herein again.

The foregoing descriptions are merely specific implementations of this application, but the protection scope of this application is not limited thereto. Any variation or replacement readily figured out by persons skilled in the art within the technical scope disclosed in this application shall fall within the protection scope of this application. Therefore, the protection scope of this application shall be subject to the protection scope of the claims.

What is claimed is:

1. A first device, comprising a processor and a memory, wherein the memory is configured to store a computer program, and the processor is configured to invoke the computer program stored in the memory and run the computer program, to cause the first device to execute a method of:
transmitting a first message to a second device, wherein the first message is used to request at least one of following operations:
downloading application model data or adding application model data;
updating application model data or modifying application model data;
uploading application model data; or
deleting application model data.

2. The first device according to claim 1, wherein the first message comprises at least one of following:
model identifier information corresponding to at least one application model that is requested to be downloaded or added;
sub-block identifier information of a model data sub-block corresponding to at least one application model that is requested to be downloaded or added;
model identifier information corresponding to at least one application model that is requested to be updated or modified;
sub-block identifier information of a model data sub-block corresponding to at least one application model that is requested to be updated or modified;
model identifier information corresponding to at least one application model that is requested to be uploaded;
model quality of service QoS requirement information corresponding to at least one application model that is requested to be uploaded;
model data size indication information corresponding to at least one application model that is requested to be uploaded;
sub-block identifier information of a model data sub-block corresponding to at least one application model that is requested to be uploaded;
QoS requirement information of a model data sub-block corresponding to at least one application model that is requested to be uploaded;
sub-block data size indication information of a model data sub-block corresponding to at least one application model that is requested to be uploaded;
model identifier information corresponding to at least one application model that is requested to be deleted; or
sub-block identifier information of a model data sub-block corresponding to at least one application model that is requested to be deleted.

3. The first device according to claim 1, wherein the first device is further configured to:
receive a second message from the second device, wherein the second message comprises at least one of following:
model identifier information corresponding to at least one application model that is allowed to be downloaded or added;
sub-block identifier information of a model data sub-block corresponding to at least one application model that is allowed to be downloaded or added;
model identifier information corresponding to at least one application model that is allowed to be updated or modified;
sub-block identifier information of a model data sub-block corresponding to at least one application model that is allowed to be updated or modified;
model identifier information corresponding to at least one application model that is allowed to be uploaded;
sub-block identifier information of a model data sub-block corresponding to at least one application model that is allowed to be uploaded;
model identifier information corresponding to at least one application model that is allowed to be deleted;
sub-block identifier information of a model data sub-block corresponding to at least one application model that is allowed to be deleted;
model identifier information corresponding to at least one application model that is not allowed to be downloaded or added;
sub-block identifier information of a model data sub-block corresponding to at least one application model that is not allowed to be downloaded or added;
model identifier information corresponding to at least one application model that is not allowed to be updated or modified;
sub-block identifier information of a model data sub-block corresponding to at least one application model that is not allowed to be updated or modified;
model identifier information corresponding to at least one application model that is not allowed to be uploaded;
sub-block identifier information of a model data sub-block corresponding to at least one application model that is not allowed to be uploaded;
model identifier information corresponding to at least one application model that is not allowed to be deleted; or
sub-block identifier information of a model data sub-block corresponding to at least one application model that is not allowed to be deleted.

4. The first device according to claim 1, wherein the first device is further configured to:
receive an application model data transmission configuration message from the second device, wherein the application model data transmission configuration message is used to determine resource configuration information for transmitting the corresponding application model data; and
receive the application model data based on the resource configuration information comprised in the application model data transmission configuration message.

5. The first device according to claim 4, wherein the first device is further configured to:
reassemble the received application model data;
wherein for reassembling the received application model data, the first device is further configured to:
reassemble the received application model data through a NAS, a packet data convergence protocol PDCP layer, a service data adaptation protocol SDAP layer, or a protocol layer dedicated to reassembly of the application model data.

6. The first device according to claim 1, wherein the first device is further configured to:
reassemble based on content of the control message, the application model data that is received via a plurality of control messages;
wherein for reassembling, based on content of the control message, the application model data that is received via a plurality of control messages, the first device is further configured to:
reassemble the received application model data through a NAS, an RRC layer, or a protocol layer dedicated to reassembly of the application model data.

7. The first device according to claim 5, wherein after the reassembling the received application model data, the first device is further configured to:
transfer reassembled application model data to an application model data management module; or
transfer reassembled application model data to a corresponding function module according to a preset rule;
wherein the preset rule comprises any one of following:
the reassembled application model data is transferred to the corresponding function module based on model identifier information corresponding to the application model data;
the reassembled application model data is transferred to the corresponding function module based on route indication information comprised in the application model data; or
the reassembled application model data is transferred to the corresponding function module based on model identifier information corresponding to the application model data and route indication information comprised in the application model data;
wherein the function module comprises any one of following: an application layer, the NAS, an RRC layer, the SDAP layer, the PDCP layer, an RLC layer, a MAC layer, a BAP layer, or a physical layer.

8. The first device according to claim 1, wherein the first device is further configured to:
determine, in a pre-configuration manner or a default manner, model data format control information corresponding to at least one application model.

9. The first device according to claim 1, wherein the first device comprises a terminal device, or the second device comprises a network device or a terminal device.

10. A second device, comprising a processor and a memory, wherein the memory is configured to store a computer program, and the processor is configured to invoke the computer program stored in the memory and run the computer program, to cause the second device to execute a method of:
receiving a first message from a first device, wherein the first message is used to request at least one of following operations:
downloading application model data or adding application model data;
updating application model data or modifying application model data;
uploading application model data; or
deleting application model data.

11. The second device according to claim 10, wherein the second device is further configured to:
transmit the first device, a control message comprising the application model data, wherein the control message comprises at least one of following:
the application model data;
model identifier information corresponding to a first application model to which the application model data belongs;
a sequence number of the application model data in the first application model;
sub-block identifier information corresponding to a first model data sub-block in a first application model to which the application model data belongs;
a sequence number of the application model data in the first model data sub-block;
control message indication information, wherein the control message indication information is used to indicate whether a current control message is a last segment of a control message; or
a control message segment sequence number, wherein the control message segment sequence number is used to indicate a segment sequence number of a current control message in a control message.

12. The second device according to claim 10, wherein the second device is further configured to:
receive a third message from the first device, wherein the third message is used to request performing an operation related to registration of the application model data, and/or used to request obtaining model data format control information;
wherein the third message comprises at least one of following:
model identifier information corresponding to at least one application model that is requested to be registered;
model identifier information corresponding to at least one application model whose registration is requested to be updated;
model identifier information corresponding to at least one application model that is requested to be de-registered; or
indication information that requests obtaining the model data format control information.

13. The second device according to claim 10, wherein the second device is further configured to: transmit a fourth message to the first device, wherein the fourth message comprises at least one of following:
model identifier information corresponding to at least one application model that has been registered successfully;
model data format control information corresponding to at least one application model that has been registered successfully;
operation condition control information corresponding to at least one application model that has been registered successfully;
model identifier information corresponding to at least one application model that fails to be registered;
failure cause information corresponding to at least one application model that fails to be registered;
model identifier information corresponding to at least one application model whose registration has been updated successfully;
model data format control information corresponding to at least one application model whose registration has been updated successfully;
operation condition control information corresponding to at least one application model whose registration has been updated successfully;
model identifier information corresponding to at least one application model whose registration fails to be updated;
failure cause information corresponding to at least one application model whose registration fails to be updated;
model identifier information corresponding to at least one application model that has been de-registered successfully;
model identifier information corresponding to at least one application model that fails to be de-registered; or
failure cause information corresponding to at least one application model that fails to be de-registered.

14. The second device according to claim 12, wherein the model data format control information comprises at least one of following:
model QoS requirement information corresponding to an application model;
model data size indication information corresponding to an application model;
model check control information corresponding to an application model;
model transmission security-related control information corresponding to an application model; or
model data block control information corresponding to an application model;
wherein the model data block control information corresponding to an application model comprises at least one of following:
a quantity of model data sub-blocks corresponding to one application model;
sub-block identifier information corresponding to each model data sub-block;
QoS requirement information corresponding to each model data sub-block;
data size indication information corresponding to each model data sub-block;
check control information corresponding to each model data sub-block; or
model transmission security-related control information corresponding to each model data sub-block.

15. The second device according to claim 10, wherein the second device is further configured to:
receive first capability indication information from the first device, wherein the first capability indication information is used to indicate whether the first device is capable of supporting an application model-related operation.

16. The second device according to claim 10, wherein the second device is further configured to:
transmit on/off indication information to the first device, wherein the on/off indication information is used to indicate whether the first device is allowed to perform an application model-related operation.

17. The second device according to claim 15, wherein the application model-related operation comprises at least one of following:
downloading the application model data or adding the application model data;
updating the application model data or modifying the application model data;
uploading the application model data;
deleting the application model data;
registering the application model data;
updating registration of the application model data;
de-registering the application model data; or
requesting obtaining format control information of the application model data.

18. A communication method, comprising:
transmitting, by a first device, a first message to a second device, wherein the first message is used to request at least one of following operations:
downloading application model data or adding application model data;
updating application model data or modifying application model data;
uploading application model data; or
deleting application model data.

19. The method according to claim 18, wherein the first message comprises at least one of following:
model identifier information corresponding to at least one application model that is requested to be downloaded or added;
sub-block identifier information of a model data sub-block corresponding to at least one application model that is requested to be downloaded or added;
model identifier information corresponding to at least one application model that is requested to be updated or modified;
sub-block identifier information of a model data sub-block corresponding to at least one application model that is requested to be updated or modified;
model identifier information corresponding to at least one application model that is requested to be uploaded;
model quality of service QoS requirement information corresponding to at least one application model that is requested to be uploaded;
model data size indication information corresponding to at least one application model that is requested to be uploaded;
sub-block identifier information of a model data sub-block corresponding to at least one application model that is requested to be uploaded;
QoS requirement information of a model data sub-block corresponding to at least one application model that is requested to be uploaded;
sub-block data size indication information of a model data sub-block corresponding to at least one application model that is requested to be uploaded;
model identifier information corresponding to at least one application model that is requested to be deleted; or
sub-block identifier information of a model data sub-block corresponding to at least one application model that is requested to be deleted.

20. The method according to claim 18, further comprising:
receiving, by the first device, a second message from the second device, wherein the second message comprises at least one of following:
model identifier information corresponding to at least one application model that is allowed to be downloaded or added;
sub-block identifier information of a model data sub-block corresponding to at least one application model that is allowed to be downloaded or added;
model identifier information corresponding to at least one application model that is allowed to be updated or modified;
sub-block identifier information of a model data sub-block corresponding to at least one application model that is allowed to be updated or modified;
model identifier information corresponding to at least one application model that is allowed to be uploaded;
sub-block identifier information of a model data sub-block corresponding to at least one application model that is allowed to be uploaded;
model identifier information corresponding to at least one application model that is allowed to be deleted;
sub-block identifier information of a model data sub-block corresponding to at least one application model that is allowed to be deleted;
model identifier information corresponding to at least one application model that is not allowed to be downloaded or added;
sub-block identifier information of a model data sub-block corresponding to at least one application model that is not allowed to be downloaded or added;
model identifier information corresponding to at least one application model that is not allowed to be updated or modified;
sub-block identifier information of a model data sub-block corresponding to at least one application model that is not allowed to be updated or modified;
model identifier information corresponding to at least one application model that is not allowed to be uploaded;
sub-block identifier information of a model data sub-block corresponding to at least one application model that is not allowed to be uploaded;
model identifier information corresponding to at least one application model that is not allowed to be deleted; or
sub-block identifier information of a model data sub-block corresponding to at least one application model that is not allowed to be deleted.
